(19) United States
(12) Patent Application Publication
(10) Pub. No.: US 2007/0158200 A1
(43) Pub. Date: Jul. 12, 2007

(54) Electrochemical fabrication processes incorporating non-platable metals and/or metals that are difficult to plate on

(75) Inventors: Adam L. Cohen, Van Nuys, CA (US); Michael S. Lockard, Lake Elizabeth, CA (US); Gang Zhang, Monterey Park, CA (US)

Correspondence Address: MICROFABRICA INC.;ATT: DENNIS R. SMALLEY, 7911 HASKELL AVENUE, VAN NUYS, CA, 91406, US

(73) Assignee: Microfabrica Inc.

(21) Appl. No.: 11/478,934

(22) Filed: Jun. 29, 2006

Related U.S. Application Data
(63) Continuation-in-part of application No. 10/697,597, filed on Oct. 29, 2003.
(63) Continuation-in-part of application No. 10/841,100, filed on May 7, 2004, now Pat. No. 7,109,118.
(63) Continuation-in-part of application No. 11/139,262, filed on May 26, 2005.
(63) Continuation-in-part of application No. 10/841,383, filed on May 7, 2004, now Pat. No. 7,195,989.
(63) Continuation-in-part of application No. 11/029,216, filed on Jan. 3, 2005.
(63) Continuation-in-part of application No. 10/841,300, filed on May 7, 2004.
(63) Continuation-in-part of application No. 10/607,931, filed on Jun. 27, 2003.
(60) Provisional application No. 60/422,008, filed on Oct. 29, 2002.
(60) Provisional application No. 60/435,324, filed on Dec. 20, 2002.
(60) Provisional application No. 60/468,979, filed on May 7, 2003.
(60) Provisional application No. 60/469,053, filed on May 7, 2003.
(60) Provisional application No. 60/533,891, filed on Dec. 31, 2003.
(60) Provisional application No. 60/468,977, filed on May 7, 2003.
(60) Provisional application No. 60/534,204, filed on Dec. 31, 2003.
(60) Provisional application No. 60/574,733, filed on May 26, 2004.
(60) Provisional application No. 60/468,979, filed on May 7, 2003.
(60) Provisional application No. 60/469,053, filed on May 7, 2003.
(60) Provisional application No. 60/533,891, filed on Dec. 31, 2003.
(60) Provisional application No. 60/533,932, filed on Dec. 31, 2003.
(60) Provisional application No. 60/534,157, filed on Dec. 31, 2003.
(60) Provisional application No. 60/533,891, filed on Dec. 31, 2003.
(60) Provisional application No. 60/574,733, filed on May 26, 2004.

(51) Int. Cl. C25D 5/00; B01J 19/08

(52) U.S. Cl. 205/80; 427/457

(57) ABSTRACT

Embodiments are directed to electrochemically fabricating multi-layer three dimensional structures where each layer comprises at least one structural and at least one sacrificial material and wherein at least some metals or alloys are electrodeposited during the formation of some layers and at least some metals are deposited during the formation of some layers that are either difficult to electrodeposit and/or are difficult to electrodeposit onto. In some embodiments, the hard to electrodeposit metals (e.g. Ti, NiTi, W, Ta, Mo, etc.) may be deposited via chemical or physical vacuum deposition techniques while other techniques are used in other embodiments. In some embodiments, prior to electrodepositing metals, the surface of the previously formed layer is made to undergo appropriate preparation for receiving an electrodeposited material. Various surface preparation techniques are possible, including, for example, anodic activation, cathodic activation, and vacuum deposition of a seed layer and possibly an adhesion layer.

### RELATED APPLICATIONS

This application claims the benefit of U.S. Provisional Patent Application No. 60/695,328, filed Jun. 29, 2005; the instant application is also a continuation in part of U.S. patent application Ser. No.10/697,597, filed on Oct. 29, 2003 which claims benefit to U.S. Provisional Patent Application No. 60/422,008, filed Oct. 29, 2002 and to U.S. Provisional Patent Application No. 60/435,324, filed Dec. 20, 2002; the instant application is also a continuation in part of U.S. patent application Ser. No. 10/841,100 which in turn claims benefit of the following U.S. Provisional Patent Application 60/468,979, filed May 7, 2003; 60/469,053, filed May 7, 2003; 60/533,891, filed Dec. 31, 2003; 60/468,977, filed May 7, 2003; and 60/534,204, filed Dec. 31, 2004; the instant application is also a continuation in part of U.S. patent application Ser. No.11/139,262 which claims benefit of U.S. Provisional Patent Application No. 60/574,733, filed May 26, 2004 and is a CIP of U.S. patent application Ser. No. 10/841,383, filed May 7, 2004 which in turn claims benefit of the following U.S. Provisional Patent Applications 60/468,979, filed May 7, 2003; 60/469,053, filed May 7, 2003; and 60/533,891, filed Dec. 31, 2003; the instant application also is a continuation in part of U.S. patent application Ser. No. 11/029,216 which claims benefit of U.S. Provisional Patent Application Nos. 60/533,932, 60/534,157, 60/533,891, and 60/574,733, filed on Dec. 31, 2003, Dec. 31, 2003, Dec. 31, 2003, and May 26, 2004. This application is a continuation in part of U.S. Non-Provisional patent application Ser. Nos. 10/841,300, and 10/607,931 filed on May 7, 2004 and Jun. 27, 2003, respectively. Each of these applications in incorporated herein by reference as if set fourth in full.

### FIELD OF THE INVENTION

The present invention relates generally to the field of electrochemically fabricating multi-layer three dimensional (e.g. micro-scale or meso-scale) structures, parts, components, or devices where each layer is formed from a plurality of deposited materials and wherein at least one of the materials is a non-electroplatable metal or is a metal that is difficult to electroplate directly on.

### BACKGROUND OF THE INVENTION

A technique for forming three-dimensional structures (e.g. parts, components, devices, and the like) from a plurality of adhered layers was invented by Adam L. Cohen and is known as Electrochemical Fabrication. It is being commercially pursued by Microfabrica Inc. (formerly MEMGen® Corporation) of Burbank, Calif. under the name EFAB™. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of Microfabrica Inc. (formerly MEMGen® Corporation) of Burbank, Calif. such masks have come to be known as INSTANT MASKS™ and the process known as INSTANT MASKING™ or INSTANT MASK™ plating. Selective depositions using conformable contact mask plating may be used to form single layers of material or may be used to form multi-layer structures. The teachings of the '630 patent are hereby incorporated herein by reference as if set forth in full herein. Since the filing of the patent application that led to the above noted patent, various papers about conformable contact mask plating (i.e. INSTANT MASKING) and electrochemical fabrication have been published:

(1) A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p 161, August 1998.

(2) A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p 244, January 1999.

(3) A. Cohen, “3-D Micromachining by Electrochemical Fabrication”, Micromachine Devices, March 1999.

(4) G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated Micronanotechnology for Space Applications, The Aerospace Co., April 1999.

(5) F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999.

(6) A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999.

(7) F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November 1999.

(8) A. Cohen, “Electrochemical Fabrication (EFABTM)”, Chapter 19 of The MEMS Handbook, edited by Mohamed Gad-EI-Hak, CRC Press, 2002.

(9) Microfabrication—Rapid Prototyping's Killer Application”, pages 1-5 of the Rapid Prototyping Report, CAD/CAM Publishing, Inc., June 1999.

The disclosures of these nine publications are hereby incorporated herein by reference as if set forth in full herein.

The electrochemical deposition process may be carried out in a number of different ways as set forth in the above patent and publications. In one form, this process involves the execution of three separate operations during the formation of each layer of the structure that is to be formed:

1. Selectively depositing at least one material by electrodeposition upon one or more desired regions of a substrate.

2. Then, blanket depositing at least one additional material by electrodeposition so that the additional deposit covers both the regions that were previously selectively deposited onto, and the regions of the substrate that did not receive any previously applied selective depositions.

3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain-plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1A-1C. FIG. 1A shows a side view of a CC mask 8 consisting of a conformable or deformable (e.g. elastomeric) insulator 10 patterned on an anode 12. The anode has two functions. One is as a supporting material for the patterned insulator 10 to maintain its integrity and alignment since the pattern may be topologically complex (e.g., involving isolated “islands” of insulator material). The other function is as an anode for the electroplating operation. FIG. 1A also depicts a substrate 6 separated from mask 8. CC mask plating selectively deposits material 22 onto a substrate 6 by simply pressing the insulator against the substrate then electrodepositing material through apertures 26a and 26b in the insulator as shown in FIG. 1B. After deposition, the CC mask is separated, preferably non-destructively, from the substrate 6 as shown in FIG. 1C. The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1D-1G. FIG. 1D shows an anode 12′ separated from a mask 8′ that includes a patterned conformable material 10′ and a support structure 20. FIG. 1D also depicts substrate 6 separated from the mask 8′. FIG. 1E illustrates the mask 8′ being brought into contact with the substrate 6. FIG. 1F illustrates the deposit 22′ that results from conducting a current from the anode 12′ to the substrate 6. FIG. 1G illustrates the deposit 22′ on substrate 6 after separation from mask 8′. In this example, an appropriate electrolyte is located between the substrate 6 and the anode 12′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, e.g. prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2A-2F. These figures show that the process involves deposition of a first material 2 which is a sacrificial material and a second material 4 which is a structural material. The CC mask 8, in this example, includes a patterned conformable material (e.g. an elastomeric dielectric material) 10 and a support 12 which is made from deposition material 2. The conformal portion of the CC mask is pressed against substrate 6 with a plating solution 14 located within the openings 16 in the conformable material 10. An electric current, from power supply 18, is then passed through the plating solution 14 via (a) support 12 which doubles as an anode and (b) substrate 6 which doubles as a cathode. FIG. 2A illustrates that the passing of current causes material 2 within the plating solution and material 2 from the anode 12 to be selectively transferred to and plated on the substrate 6. After electroplating the first deposition material 2 onto the substrate 6 using CC mask 8, the CC mask 8 is removed as shown in FIG. 2B. FIG. 2C depicts the second deposition material 4 as having been blanket-deposited (i.e. non-selectively deposited) over the previously deposited first deposition material 2 as well as over the other portions of the substrate 6. The blanket deposition occurs by electroplating from an anode (not shown), composed of the second material, through an appropriate plating solution (not shown), and to the cathode/substrate 6. The entire two-material layer is then planarized to achieve precise thickness and flatness as shown in FIG. 2D. After repetition of this process for all layers, the multi-layer structure 20 formed of the second material 4 (i.e. structural material) is embedded in first material 2 (i.e. sacrificial material) as shown in FIG. 2E. The embedded structure is etched to yield the desired device, i.e. structure 20, as shown in FIG. 2F.

Various components of an exemplary manual electrochemical fabrication system 32 are shown in FIGS. 3A-3C. The system 32 consists of several subsystems 34, 36, 38, and 40. The substrate holding subsystem 34 is depicted in the upper portions of each of FIGS. 3A-3C and includes several components: (1) a carrier 48, (2) a metal substrate 6 onto which the layers are deposited, and (3) a linear slide 42 capable of moving the substrate 6 up and down relative to the carrier 48 in response to drive force from actuator 44. Subsystem 34 also includes an indicator 46 for measuring differences in vertical position of the substrate which may be used in setting or determining layer thicknesses and/or deposition thicknesses. The subsystem 34 further includes feet 68 for carrier 48 which can be precisely mounted on subsystem 36.

The CC mask subsystem 36 shown in the lower portion of FIG. 3A includes several components: (1) a CC mask 8 that is actually made up of a number of CC masks (i.e. submasks) that share a common support/anode 12, (2) precision X-stage 54, (3) precision Y-stage 56, (4) frame 72 on which the feet 68 of subsystem 34 can mount, and (5) a tank 58 for containing the electrolyte 16. Subsystems 34 and 36 also include appropriate electrical connections (not shown) for connecting to an appropriate power source (not shown) for driving the CC masking process.

The blanket deposition subsystem 38 is shown in the lower portion of FIG. 3B and includes several components: (1) an anode 62, (2) an electrolyte tank 64 for holding plating solution 66, and (3) frame 74 on which feet 68 of subsystem 34 may sit. Subsystem 38 also includes appropriate electrical connections (not shown) for connecting the anode to an appropriate power supply (not shown) for driving the blanket deposition process.

The planarization subsystem 40 is shown in the lower portion of FIG. 3C and includes a lapping plate 52 and associated motion and control systems (not shown) for planarizing the depositions.

In addition to teaching the use of CC masks for electrodeposition purposes, the '630 patent also teaches that the CC masks may be placed against a substrate with the polarity of the voltage reversed and material may thereby be selectively removed from the substrate. It indicates that such removal processes can be used to selectively etch, engrave, and polish a substrate, e.g., a plaque.

The '630 patent further indicates that the electroplating methods and articles disclosed therein allow fabrication of devices from thin layers of materials such as, e.g., metals, polymers, ceramics, and semiconductor materials. It further indicates that although the electroplating embodiments described therein have been described with respect to the use of two metals, a variety of materials, e.g., polymers, ceramics and semiconductor materials, and any number of metals can be deposited either by the electroplating methods therein, or in separate processes that occur throughout the electroplating method. It indicates that a thin plating base can be deposited, e.g., by sputtering, over a deposit that is insufficiently conductive (e.g., an insulating layer) so as to enable subsequent electroplating. It also indicates that multiple support materials (i.e. sacrificial materials) can be included in the electroplated element allowing selective removal of the support materials.

The '630 patent additionally teaches that the electroplating methods disclosed therein can be used to manufacture elements having complex microstructure and close tolerances between parts. An example is given with the aid of FIGS. 14A-14E of that patent. In the example, elements having parts that fit with close tolerances, e.g., having gaps between about 1-5 um, including electroplating the parts of the device in an unassembled, preferably pre-aligned, state and once fabricated. In such embodiments, the individual parts can be moved into operational relation with each other or they can simply fall together. Once together the separate parts may be retained by clips or the like.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers”. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer. The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation.

The '637 patent teaches the locating of a plating base onto a substrate in preparation for electroplating materials onto the substrate. The plating base is indicated as typically involving the use of a sputtered film of an adhesive metal, such as chromium or titanium, and then a sputtered film of the metal that is to be plated. It is also taught that the plating base may be applied over an initial sacrificial layer of material on the substrate so that the structure and substrate may be detached if desired. In such cases after formation of the structure the plating base may be patterned and removed from around the structure and then the sacrificial layer under the plating base may be dissolved to free the structure. Substrate materials mentioned in the '637 patent include silicon, glass, metals, and silicon with protected processed semiconductor devices. A specific example of a plating base includes about 150 angstroms of titanium and about 300 angstroms of nickel, both of which are sputtered at a temperature of 160° C. In another example it is indicated that the plating base may consist of 150 angstroms of titanium and 150 angstroms of nickel where both are applied by sputtering.

Electrochemical Fabrication provides the ability to form prototypes and commercial quantities of miniature objects, parts, structures, devices, and the like at reasonable costs and in reasonable times. In fact, Electrochemical Fabrication is an enabler for the formation of many structures that were hitherto impossible to produce. Electrochemical Fabrication opens the spectrum for new designs and products in many industrial fields. Even though Electrochemical Fabrication offers this new capability and it is understood that Electrochemical Fabrication techniques can be combined with designs and structures known within various fields to produce new structures, certain uses for Electrochemical Fabrication provide designs, structures, capabilities and/or features not known or obvious in view of the state of the art.

A need exists in various fields for miniature devices having improved characteristics, reduced fabrication times, reduced fabrication costs, simplified fabrication processes, greater versatility in device design, improved selection of materials, improved material properties, more cost effective and less risky production of such devices, and/or more independence between geometric configuration and the selected fabrication process.

### SUMMARY OF THE INVENTION

It is an object of some aspects of the invention to provide an improved method for forming multi-layer three-dimensional structures where a structural material included on one or more layers is a metal that cannot be readily (e.g. in a commercially reasonable manner) electroplated or on which it is difficult to electroplate other metals

It is an object of some aspects of the invention to provide an improved method for forming multi-layer three-dimensional structures where a shape memory alloy (e.g. nickel titanium, NiTi) is included on one or more layers as a structural material

Other objects and advantages of various aspects and embodiments of the invention will be apparent to those of skill in the art upon review of the teachings herein. The various aspects of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

A first aspect of the invention provides an improved method of forming a multi-layer three-dimensional structure, including: (A) forming a plurality of successive layers of the structure with each successive layer, except for a first layer, adhered to a previously formed layer and with each successive layer comprising at least two materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement includes: depositing the first material via an electrodeposition process during formation of a given layer; depositing the second material via a non-electrodeposition process during formation of a given layer; wherein the first material is a metal and wherein the second material is an HDET metal, and wherein the first material is the sacrificial material and the second material is the structural material.

A second aspect of the invention provides an improved method of forming a multi-layer three-dimensional structure, including: (A) forming a plurality of successive layers of the structure with each successive layer, except for a first layer, adhered to a previously formed layer and with each successive layer comprising at least two materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement includes: depositing the first material via a non-electrodeposition process during formation of a given layer; depositing the second material via an electrodeposition process during formation of the given layer; wherein the first material is an HDET metal and wherein the second material is a metal, and wherein the first material is the structural material and the second material sacrificial material.

A second aspect of the invention provides an improved method of forming a multi-layer three-dimensional structure, including: (A) forming a plurality of successive layers of the structure with each successive layer, except for a first layer, adhered to a previously formed layer and with each successive layer comprising at least three materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement includes: depositing a first material structural or sacrificial material during formation of a given layer; depositing a second structural or sacrificial material during formation of the given layer, depositing a third structural or sacrificial material during formation of the given layer; wherein at least one of the first-third materials is a sacrificial material, at least one of the first-third materials is a structural material, at least two of the first-third materials are metals, and least one of the metals is electrodeposited, and at least one structural material is an HDET metal

Other aspects of the invention will be understood by those of skill in the art upon review of the teachings herein. Other aspects of the invention may involve combinations of the above noted aspects of the invention. Other aspects of the invention may involve apparatus that can be used in implementing one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1A-1C schematically depict side views of various stages of a CC mask plating process, while FIGS. 1D-G schematically depict a side views of various stages of a CC mask plating process using a different type of CC mask.

FIGS. 2A-2F schematically depict side views of various stages of an electrochemical fabrication process as applied to the formation of a particular structure where a sacrificial material is selectively deposited while a structural material is blanket deposited.

FIGS. 3A-3C schematically depict side views of various example subassemblies that may be used in manually implementing the electrochemical fabrication method depicted in FIGS. 2A-2F.

FIGS. 4A-4F schematically depict the formation of a first layer of a structure using adhered mask plating where the blanket deposition of a second material overlays both the openings between deposition locations of a first material and the first material itself

FIG. 4G depicts the completion of formation of the first layer resulting from planarizing the deposited materials to a desired level.

FIGS. 4H and 4I respectively depict the state of the process after formation of the multiple layers of the structure and after release of the structure from the sacrificial material.

FIG. 5 provides a block diagram of the major steps in a process according to a first group of embodiments where a first structural or sacrificial material is electrolytically deposited and a second structural or sacrificial material is an HTED metal or alloy and is thus non-electrolytically deposited.

FIG. 6A provides a block diagram of the major steps in a process according to a second group of embodiments where a first structural or sacrificial material is an HTED metal or alloy and thus is non-electrolytically deposited and a second structural or sacrificial material is electrolytically deposited and more particularly where the first material is selectively deposited.

FIG. 6B provides a block diagram of the major steps in a process according to a second group of embodiments where a first structural or sacrificial material is an HTED metal or alloy and is thus non-electrolytically deposited and a second structural or sacrificial material is electrolytically deposited and more particularly where the first material is blanket deposited to cover and fill voids in a masking material.

FIG. 6C provides a block diagram of the major steps in a process according to a second group of embodiments where a first structural or sacrificial material is and HTED metal or alloy and is thus non-electrolytically deposited and a second structural or sacrificial material is electrolytically deposited and more particularly where the first material is blanket deposited and is then patterned to form voids into which the second material can be deposited.

FIG. 7A provides a block diagram of the major steps in a process according to a third group of embodiments which is similar to the process of FIG. 6A with the exception that the second material is also an HTED metal or alloy and is thus non-electrolytically deposited.

FIG. 7B provides a block diagram of the major steps in a process according to a third group of embodiments which is similar to the process of FIG. 6B with the exception that the second material is also an HTED metal or alloy and is thus non-electrolytically deposited.

FIG. 7C provides a block diagram of the major steps in a process according to a third group of embodiments which is similar to the process of FIG. 6C with the exception that the second material is also an HTED metal or alloy and is thus non-electrolytically deposited.

FIG. 8 provides. a block diagram of the major steps (along with various alternatives) in a process according to a fourth group of embodiments where the number of materials deposited per layer is variable.

FIGS. 9A-9F depict schematic side views of various states of a first specific embodiment of the first group of embodiments as applied to an example structure, where the second material is an HTED metal or alloy and is thus deposited in a non-electrolytic manner.

FIGS. 10A-10F depict schematic side views of various states of a more detailed example of the first specific embodiment of the second group of embodiments and in particular of the process of FIG. 6B as applied to an example structure, where the first material is an HTED metal or alloy and is thus a patterned via non-electrolytic deposition.

FIGS. 11A-11H depict schematic side views of various states of a second specific embodiment of the first group of embodiments where the second material is an HTED metal or alloy and is thus deposited in a non-electrolytic, flowable form (e.g., a liquid, a paste, or a powder nor requiring consolidation).

FIGS. 12A-12H depict schematic side views of various states of a third specific embodiment of the first group of embodiments where the first material is deposited electrolytically and the second material is an HTED metal or alloy and is deposited in a powder form that requires consolidation.

FIGS. 13A-13H depict schematic side views of various states of a fourth specific embodiment of the first group of embodiments as applied to a specific example structure where the second material is an HTED metal or alloy and is deposited in sheet form, then deformed mechanically, sonically, and/or thermally.

FIGS. 14A-14N depict various states of a process for forming a three-dimensional structure according to a fifth specific embodiment of the first group of embodiments of the invention in which multilayer structures of nickel titanium (NiTi), tantalum (Ta), or titanium (Ti) or other material (HTED metal) that is difficult to plate onto can be fabricated.

FIGS. 16A-15H depict various states of a process for forming a three-dimensional structure according to a sixth specific embodiment of the first group of embodiments of the invention in which a coating of the sacrificial material to be electrodeposited over a previously formed layer that contains or may contain a structural material that is hard to electroplate over (i.e. an HTED metal, e.g. NiTi) is first applied using vacuum processing and then increased in height via electroplating.

FIGS. 16A-16I depict various states of a process for forming a three-dimensional structure according to a seventh specific embodiment of the first group of embodiments of the invention in which a coating of the sacrificial material, to be electrodeposited, over a previously formed layer that contains or may contain a structural material that is hard to electroplate over (i.e. an HTED metal, e.g. NiTi) is first applied to selected portions of a previously formed layer via voids in a masking material and prior to thickening the coating of the first material, a lift off process is used to remove the vacuum deposited material from above the masking material.

FIGS. 17A-17J depict various states of a process for forming a three-dimensional structure according to an eighth specific embodiment of the first group of embodiments of the invention in which a coating of the sacrificial material, to be electrodeposited, over a previously formed layer that contains or may contain a structural material that is hard to electroplate over (i.e. an HTED metal, e.g. NiTi) is first applied over the entire previous layer via a blanket vacuum deposition after which masking material is applied and the material patterned via etching.

FIGS. 18A-18C provide various views of a sputtering fixture and components thereof that allow controlled sputtering on a surface of a wafer.

FIGS. 19A-19D illustrate an example device that self-assembles as a result of undergoing temperature changes. FIGS. 21A-21D depict, in cross-section, an arrangement/process which allows wafer-scale electropolishing of a fabricated device located on a substrate.

FIG. 20 provides an example of a typical bimorph device with a high CTE material on the top and a relatively low CTE material on the bottom.

FIG. 21 provides another example of a bimorph in which the top material is a high CTE material and the bottom material is a shape memory material.

FIGS. 23A-23E illustrate an embodiment where mandrels for shape-setting are co-fabricated along with devices.

### DETAILED DESCRIPTION OF PREFERRED EMBODIMENTS OF THE INVENTION

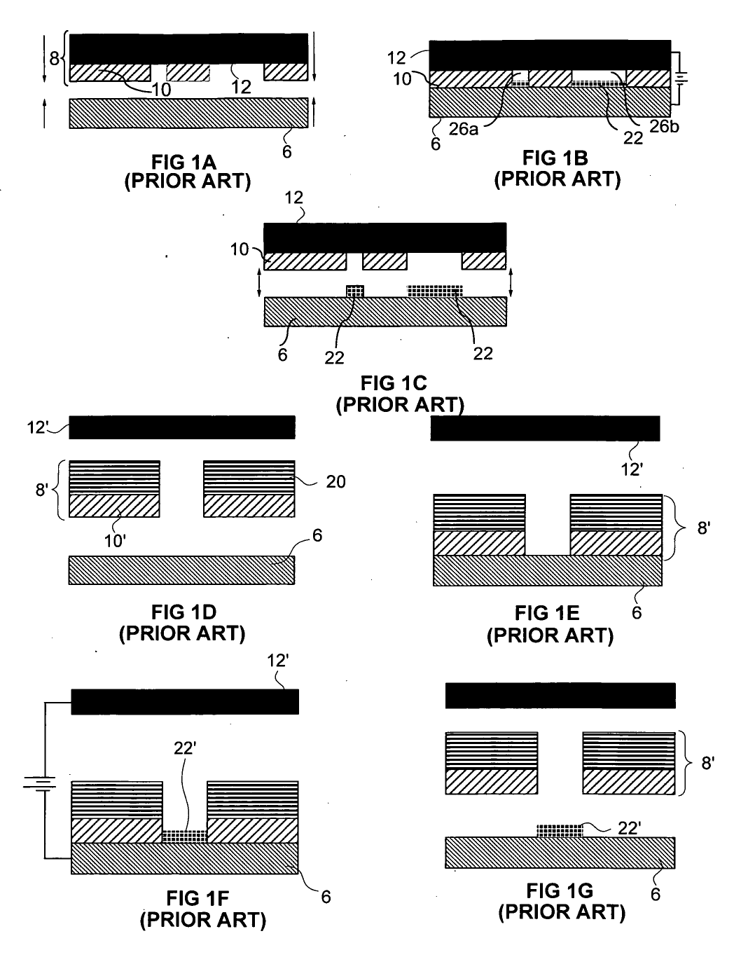

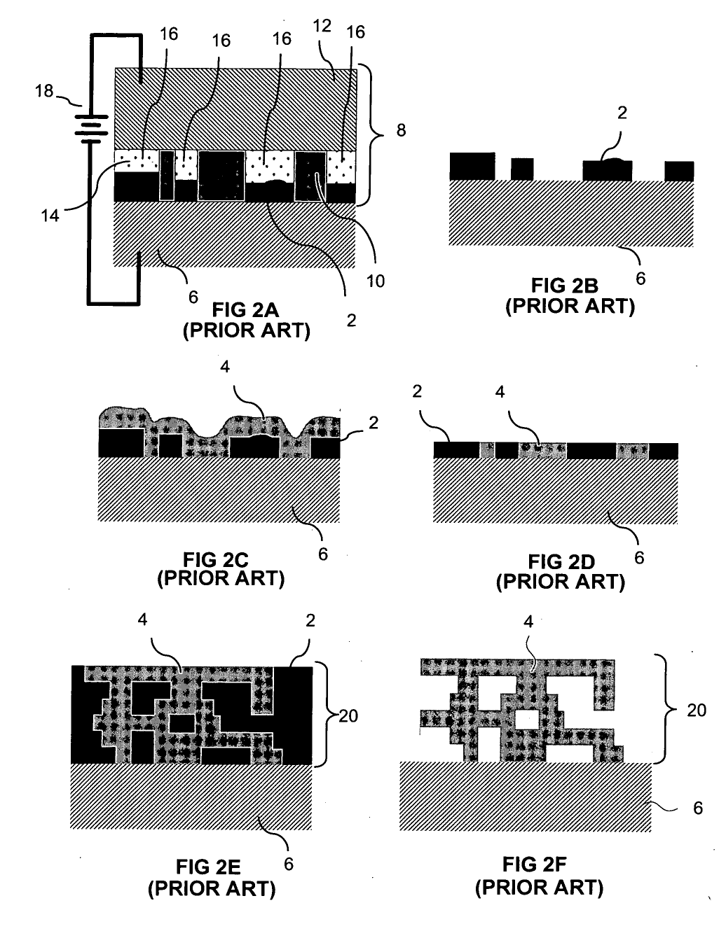

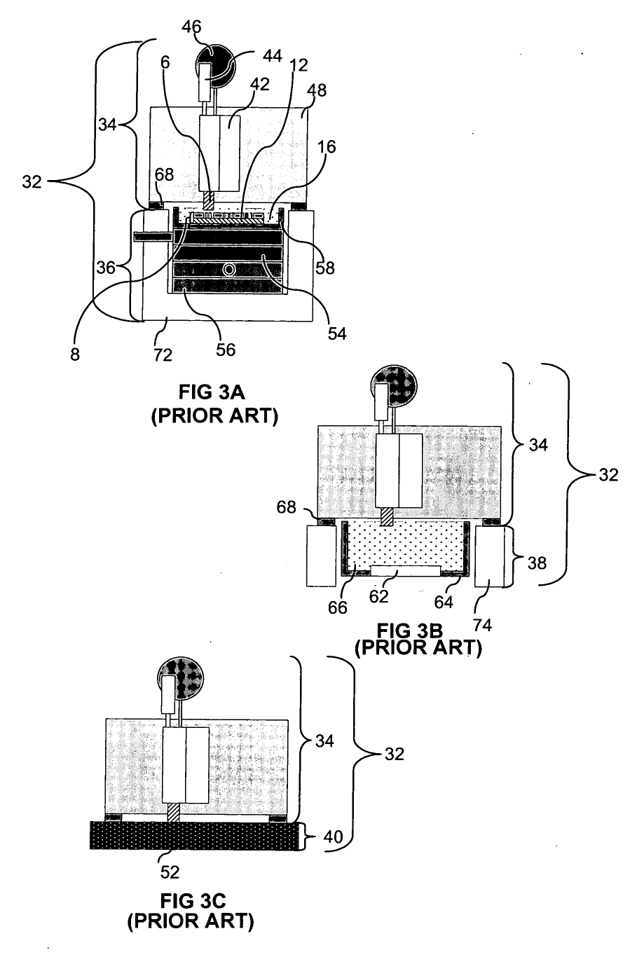

FIGS. 1A-1G, 2A-2F, and 3A-3C illustrate various features of one form of electrochemical fabrication that are known. Other electrochemical fabrication techniques are set forth in the '630 patent referenced above, in the various previously incorporated publications, in various other patents and patent applications incorporated herein by reference, still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments may be derived from combinations of the various embodiments explicitly set forth herein.

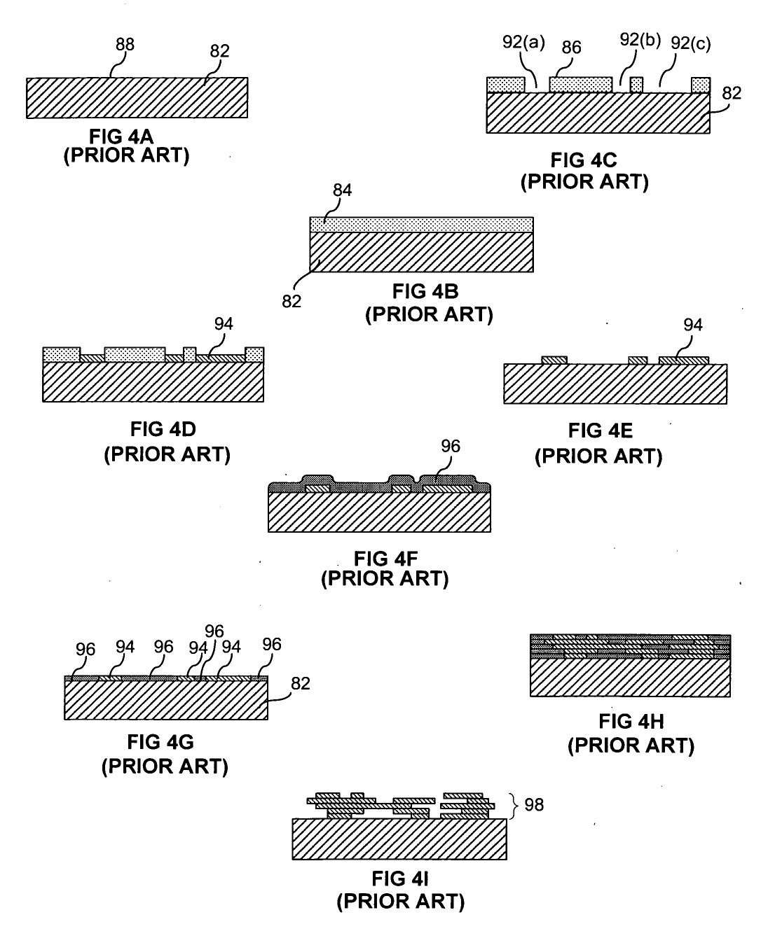

FIGS. 4A-4I illustrate various stages in the formation of a single layer of a multi-layer fabrication process where a second metal is deposited on a first metal as well as in openings in the first metal so that the first and second metal form part of the layer. In FIG. 4A a side view of a substrate 82 is shown, onto which patternable photoresist 84 is cast as shown in FIG. 4B. In FIG. 4C, a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4D a metal 94 (e.g. nickel) is shown as having been electroplated into the openings 92(a)-92(c). In FIG. 4E the photoresist has been removed (i.e. chemically stripped) from the substrate to expose regions of the substrate 82 which are not covered with the first metal 94. In FIG. 4F a second metal 96 (e.g. silver) is shown as having been blanket electroplated over the entire exposed portions of the substrate 82 (which is conductive) and over the first metal 94 (which is also conductive). FIG. 4G depicts the completed first layer of the structure which has resulted from the planarization of the first and second metals down to a height that exposes the first metal and sets a thickness for the first layer. In FIG. 4H the result of repeating the process steps shown in FIGS. 4B-4G several times to form a multi-layer structure are shown where each layer consists of two materials. For most applications, one of these materials is removed as shown in FIG. 4I to yield a desired 3-D structure 98 (e.g. component or device).

Various embodiments of various aspects of the invention are directed to formation of three-dimensional structures from materials some of which may be electrodeposited or electroless deposited. Some of these structures may be formed form a single layer of one or more deposited material while others are formed from a plurality of layers each including at least two materials (e.g. 2 or more layers, more preferably five or more layers, and most preferably ten or more layers). In some embodiments structures having features positioned with micron level precision and minimum features size on the order of tens of microns are to be formed. In other embodiments structures with less precise feature placement and/or larger minimum features may be formed. In still other embodiments, higher precision and smaller minimum feature sizes may be desirable.

The various embodiments, alternatives, and techniques disclosed herein may form multi-layer structures using a single patterning technique on all layers or using different patterning techniques on different layers. For example, Various embodiments of the invention may perform selective patterning operations using conformable contact masks and masking operations (i.e. operations that use masks which are contacted to but not adhered to a substrate), proximity masks and masking operations (i.e. operations that use masks that at least partially selectively shield a substrate by their proximity to the substrate even if contact is not made), non-conformable masks and masking operations (i.e. masks and operations-based on masks whose contact surfaces are not significantly conformable), and/or adhered masks and masking operations (masks and operations that use masks that are adhered to a substrate onto which selective deposition or etching is to occur as opposed to only being contacted to it). Adhered mask may be formed in a number of ways including (1) by application of a photoresist, selective exposure of the photoresist, and then development of the photoresist, (2) selective transfer of pre-patterned masking material, and/or (3) direct formation of masks from computer controlled depositions of material.

Patterning operations may be used in selectively depositing material and/or may be used in the selective etching of material. Selectively etched regions may be selectively filled in or filled in via blanket deposition, or the like, with a different desired material. In some embodiments, the layer-by-layer build up may involve the simultaneous formation of portions of multiple layers. In some embodiments, depositions made in association with some layer levels may result in depositions to regions associated with other layer levels. Such use of selective etching and interlaced material deposited in association with multiple layers is described in U.S. patent application Ser. No. 10/434,519, by Smalley, and entitled “Methods of and Apparatus for Electrochemically Fabricating Structures Via Interlaced Layers or Via Selective Etching and Filling of Voids layer elements” which is hereby incorporated herein by reference as if set forth in full.

In the present application the following terms are generally intended to have the following definitions though the meaning of particular terms as used in particular contexts may vary from these definitions if the context makes it clear what the term is intended to mean in that circumstance.

The terms “three-dimensional structure”, “structure”, “part”, “component”, “device”, and the like shall refer generally to intended or actually fabricated three-dimensional configurations (e.g. of structural material) that are intended to be used for a particular purpose. Such structures, etc. may, for example, be designed with the aid of a three-dimensional CAD system. In some embodiments, such structures may be formable from a single layer of structural material while in most embodiments, such structures will be formable from a plurality of adhered layers. When designing such structures, for example, the formation process that will be used in fabricating the structure may or may not be taken into consideration. For example, if the structure is to be formed from a plurality of adhered layers, it may be desirable to take into consideration the vertical levels that define layer transitions so that structural features are precisely located at layer boundary levels. The structures may be designed with sloping sidewalls or with vertical sidewalls. In designing such a three-dimensional structures they may be designed in a positive manner (i.e. features of the structure itself defined) or in a negative manner (i.e. regions or features of sacrificial material within a build volume defined), or as a combination of both.

The terms “build axis” or “build orientation” refer to a direction that is generally perpendicular to the planes of layers from which a three-dimensional structure is formed and it points in the direction from previously formed layers to successively formed layers. The build orientation will generally be considered to extend in the vertical direction regardless of the actual orientation, with respect to gravity, of the build axis during layer formation (e.g. regardless of whether the direction of layer stacking is horizontal relative to the earth's gravity, upside down relative to gravity, or at some other angle relative to the earth's gravity).

The term “structural material” shall generally refer to one or more particular materials that are deposited during formation of one or more build layers at particular lateral positions, where the material is generally intended to form part or all of a final three-dimensional structure and where thicknesses of the particular material associated with one or more particular layers is typically substantially that of the thickness of that layer or the thicknesses of those layers. During formation of particular layers, structural material thickness may vary from the layer thicknesses by generally relative thin adhesion layer thicknesses, seed layer thicknesses, barrier layer thicknesses, or the like, or at edges of features where sloping sidewalls may exist. In some embodiments, the structural material associated with particular layers may be formed from a plurality of distinctly deposited material whose combination defines an effective structural material.

The term “sacrificial material” shall generally refer to one or more particular materials that are deposited during formation of one or more build layers at particular lateral positions, where the material is generally intended to be removed from a final three-dimensional structure prior to putting it to its intended use. Sacrificial material does not generally refer to masking materials, or the like, that are applied during formation of a particular layer and then removed prior to completion of formation of that layer. Sacrificial material generally forms a portion of a plurality of build layers and is separated from structural material after formation of a plurality of layers (e.g. after completion of formation of all build layers. Some portion of a sacrificial material may become a pseudo structural material if it is completely encapsulated or effectively trapped by structural material such that it is not removed prior to putting the structure to use. For example, a copper sacrificial material may be intentionally encapsulated by a structural material (e.g. nickel or a nickel alloy) so as to improve thermal conductive or electrical conductive of the structure as a whole. The thicknesses of a particular sacrificial material associated with one or more particular layers is typically substantially that of the thickness of that layer or the thicknesses of those layers. During formation of particular layers, sacrificial material thickness may vary from the layer thicknesses by generally relative thin adhesion material thicknesses, seed material thicknesses, barrier material thicknesses, or the like, or at edges of features where sloping sidewalls may exist. In some embodiments, the sacrificial material associated with particular layers may be formed from a plurality of distinctly deposited material whose combination defines an effective structural material.

The term “build layer”, “structural layer”, or simply “layer” generally refers to materials deposited within a build volume located between two planes spaced by a “layer thickness” along the build axis where at least one structural material exists in one or more lateral positions and at least one sacrificial material exists in one or more other lateral positions. During fabrication, build layers are generally stacked one upon another but in some embodiments, it is possible that build layers will be separated one from another, in whole or in part, by relative thin coatings of adhesion layer material, seed layer material, barrier layer material, or the like.

The term “layer thickness” is the height along the build axis between a lower boundary of a build layer and an upper boundary of that build layer. Layer thicknesses, for example may be in the two micron to fifty micron range, with ten micron to 30 micron being common. In some embodiments layer thicknesses may be thinner than 2 microns or thicker than fifty microns. In many embodiments, deposition thickness (i.e. the thickness of any particular material after it is deposited) is generally greater than the layer thickness and a net deposit thickness is set via one or more planarization processes which may include, for example, mechanical abrasion (e.g. lapping, fly cutting, polishing, and the like) and/or chemical etching (e.g. using selective or non-selective etchants). The lower boundary and upper boundary for a build layer may be set and defined in different ways. From a design point of view they may be set based on a desired vertical resolution of the structure (which may vary with height). From a data manipulation point of view, the vertical layer boundaries may be defined as the vertical levels at which data descriptive of the structure is processed or the layer thickness may be defined as the height separating successive levels of cross-sectional data that dictate how the structure will be formed. From a fabrication point of view, depending on the exact fabrication process used, the layer boundaries may be defined in a variety of different ways. For example by planarization levels or effective planarization levels (e.g. lapping levels, fly cutting levels, chemical mechanical polishing levels, mechanical polishing levels, vertical positions of structural and/or sacrificial materials after relatively uniform etch back following a mechanical or chemical mechanical planarization process). For example, by levels at which process steps or operations are repeated. At levels at which, at least theoretically, lateral extends of structural material can be changes to define new cross-sectional features of a structure.

The terms “adhesion layer”, “seed layer”, “barrier layer”, and the like refer to coatings of material that are thin in comparison to the layer thickness (e.g. less than 20% of the layer thickness, more preferably less than 10% of the layer thickness, and even more preferably less than 5% of the layer thickness). Such coatings may be applied uniformly over a previously formed layer, they may be applied over a portion of a previously formed layer and over patterned structural or sacrificial material existing on a current layer so that a non-planar seed layer results, or they may be selectively applied to only certain locations on a previously formed layer. In the event such coatings are non-selectively applied they may be removed (1) prior to depositing either a sacrificial material or structural material as part of a current layer or (2) prior to beginning formation of the next layer or they may remain in place through the layer build up process and then etched away after formation of a plurality of layers where the thinness of the coating may be relied on so that undercutting of structural material on two consecutive layers is not excessive and/or where thinness of the coatings may be relied on for their destructive removal between regions of sacrificial material located on successive layers.

The term “structural layer” shall refer to one or more structural materials deposited during formation of a particular build layer or to the configuration of such material within the lower and upper boundaries of the layer.

The term “sacrificial layer” shall refer to the one or more sacrificial materials deposited during formation of a particular build layer or to the configuration of such material within the lower and upper boundaries of the layer.

Various embodiments of the invention relate to methods and apparatus for fabricating structures using an EFAB technology-like processes in which at least one material, e.g. the structural material, is a metal or alloy that is difficult to commercially electrodeposit and/or is difficult to commercially and directly electrodeposit a metal thereon and which is deposited by other than electrolytic deposition operations or steps, electroless deposition operations or steps, or metal spraying operations or steps (e.g., cold spray or plasma spray). Such materials shall be referred to herein as “HTED metals or alloys”. These alternative deposition approaches may include vacuum deposition/physical vapor deposition (PVD, e.g., sputtering, evaporation, low temperature arc vapor deposition (e.g., from Vapor Technologies, Inc.), vacuum arc vaporization, reactive evaporation, molecular beam epitaxy, ionized cluster beam deposition), chemical vapor deposition (CVD, e.g., low pressure chemical vapor deposition, plasma-enhanced chemical vapor deposition, chemical vapor infiltration (Ultramet, Pacoima, Calif.)), ion-beam-assisted deposition, arc deposition, pulsed-laser deposition, diffusion coating. In some embodiments deposition of a structural material may occur via melting/sintering/thermal or sonic consolidation of powders or sheets (including ultrasonic consolidation of the sort practiced by Solidica of Ann Arbor, Mich.), casting. In some embodiments the difficult to de, molding processes (e.g., injection or transfer molding) in which the material is applied as a liquid, paste, slurry, semi-solid, or powder, sol-gel processes, mechanical plating, ion plating, electrophoretic deposition (and if required, subsequent consolidation), spray coating, dip coating, roller coating, and inkjet deposition.

Structures, components, or devices produced by the method embodiments of the invention may include, for example, the fabrication of biomedical devices such as surgical instruments and implants (e.g., stents, implantable drug-delivery pumps, pressure sensors, and implanted orthopaedic bone-ingrowth surfaces), inkjet printheads, devices having desired shape memory functionality, and the like. Various metals and alloys such as NiTi, Ti, Ta, and certain Liquidmetal® materials produced by Liquid Metal Technologies of Lake Forrest, Calif. may be used as structural materials (at least on some layers).

### Examples of Metals and Alloys for Use in Some Embodiments

In specific embodiments, selected materials may be used in combination with selected deposition operations. The selected deposition techniques are those that are appropriate for materials to be deposited and for the process as a whole. Such materials and processes include, for example:

(1) NiTi and other ‘smart’ alloys (e.g., Nitinol), Ti, and Zr. These materials may be deposited by sputtering. Sputtering of relatively thick (several μm to 10s of μm), relatively low-stress films of NiTi at a reasonable deposition rates (e.g., several pm per hour) is known in the art and is commonly carried out by such companies as TiNi Alloy of San Leandro, Calif. and Shape Change Technologies of Thousand Oaks, Calif.

(2) Materials such as Ta, Re, W, Mo, and Nb—as well as oxides, nitrides, carbides, borides, and silicides of these materials—can be deposited by CVD or chemical vapor infiltration.

(3) Materials such as Al, Mg, Sn, In, Pb, low-melting point alloys (e.g., Cerro alloys containing Bi, Pb, Sn, and In, or just Bi and Sn), and solders (e.g., Pb—Sn) may be deposited by casting or molding the material in molten form.

(4) Self-setting (e.g., mercury-containing amalgam) may be deposited by casting or molding.

(5) Materials such as Ti, Mg, and many others may be deposited in the form of powders which are then melted in place or sintered (possibly infiltrated with another material which for biomedical applications may be biocompatible).

(6) Materials such as Ti, Mg, and stainless steels may be applied in sheet form and consolidated through the application of heat, pressure, and/or sonic vibration.

(7) Materials such as Ti may be deposited by low temperature arc vapor deposition.

(8) Materials such as Al may be deposited by mechanical plating.

(9) Materials such as Ti, Mg, and Nb may be deposited by cathodic arc deposition or ion beam-assisted deposition.

(10) Proprietary materials such as biocompatible Medcoat 2000 (Electrolizing Corporation of Ohio, Cleveland, Ohio)

Difficult to electrodeposit metals or alloys and/or metals or alloys that are difficult to electrodeposit onto and which are deposited via a non-electrodeposition process, a non-electroless deposition process, and a non-spray metal deposition process shall be herein termed “HTED metals or alloys”.

First Group of Embodiments

In a first group of embodiments of the invention a process flow similar to that illustrated in FIGS. 4A-4I may be used with the exception that the second material to be deposited is not deposited in an electrolytic manner (i.e. it is deposited in a non-electrolytic manner) but instead is deposited in a manner that does not require a conductive base. In this group of embodiments the first material is deposited in an electrolytic manner (e.g. via electroplating, etc.). In some more specific embodiments in this first group, one of the non-electrolytically depositable materials (i.e. HTED materials) set forth above is used as the second material to be deposited and its deposition occurs in one of the indicated manners.

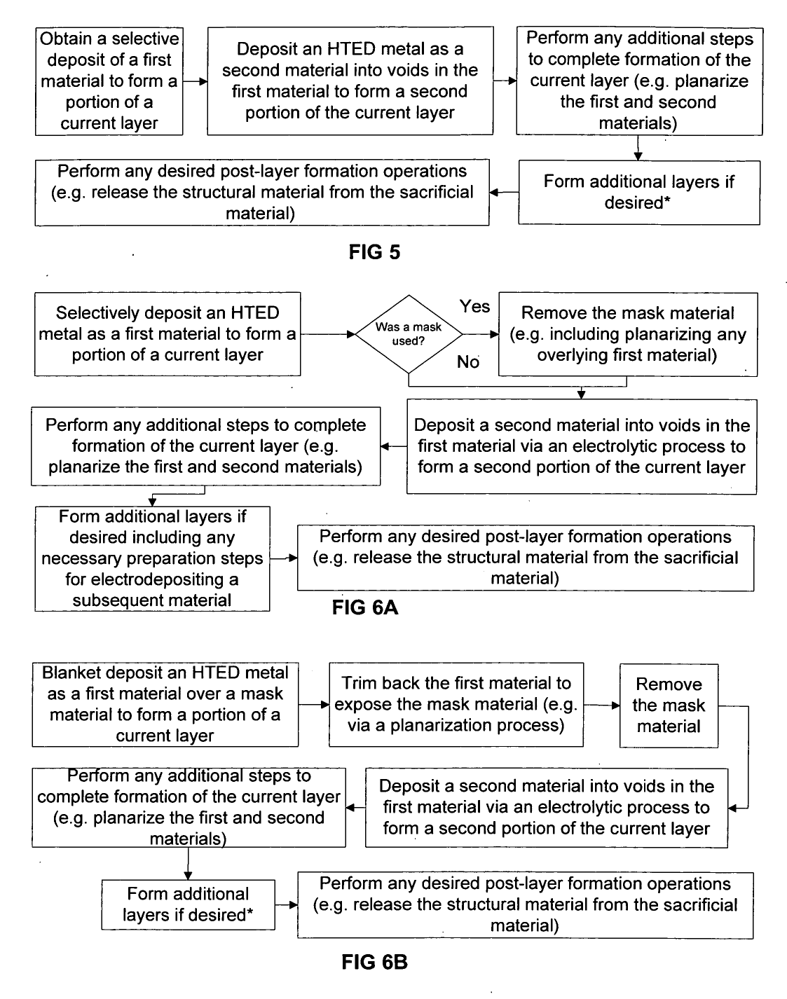

FIG. 5 provides a block diagram of the major steps in a process according to a first group of embodiments where a first structural or sacrificial material is electrolytically deposited and a second structural or sacrificial material is an HTED metal or alloy and is thus non-electrolytically deposited.

Second Group of Embodiments

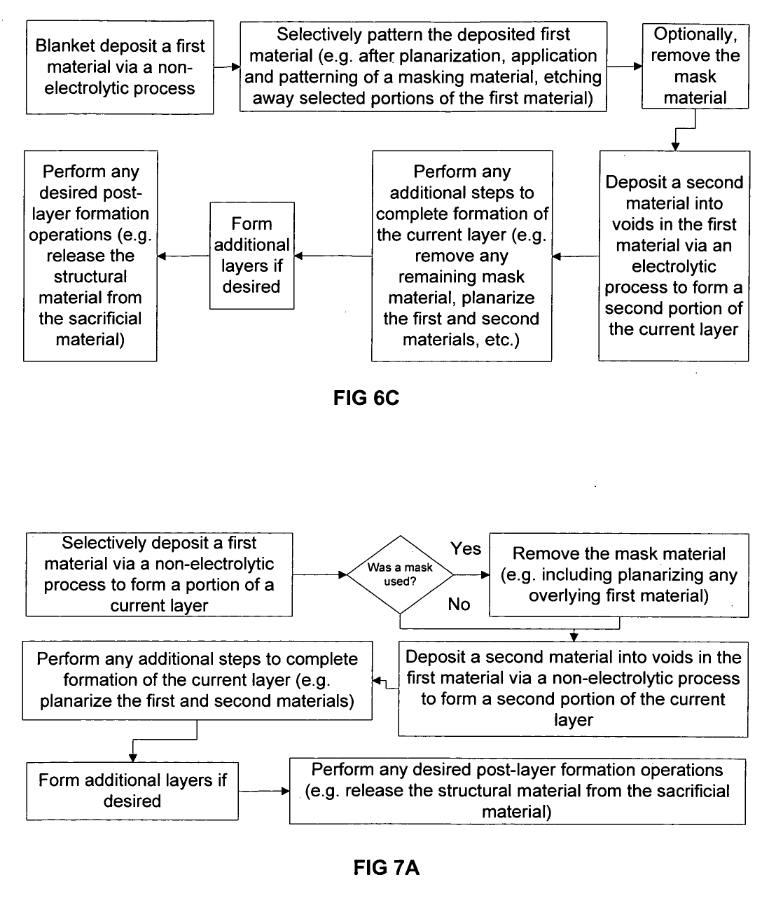

In a second group of embodiments, the first deposited material is an HTED metal or alloy and is thus deposited in a non-electrolytic manner while the second material is deposited in an electrolytic manner. The first deposited material may be (1) selectively deposited after which any mask material used in the selective deposition may be removed and then a second material deposited, (2) blanket deposited over a mold or masking material and then trimmed back to a desired vertical level (e.g. via a planarization operation or set of operations) to leave a patterned deposit of the first material after which the masking or mold material may be removed and after which a second material may be deposited, or (3) blanket deposited and then selectively patterned (e.g. via etching through a masking material which may be applied after a planarization operation or set of operations) and after which a second material may be deposited. In this second group of embodiments, if the first material deposition operation or set of operations results in an over coating of material on a masking or mold material, prior to deposition of the second material, a planarization operation or lift off operation may be necessary to expose the masking or mold material which may then be removed. In some more specific embodiments of this second group of embodiments, one of the non-electrolytically depositable materials set forth above is used as the first material to be deposited and its deposition occurs in one of the indicated manners. FIGS. 6A-6C provide block diagrams illustrating various example process flows according to this second group of embodiments.

FIG. 6A provides a block diagram of the major steps in a process according to a second group of embodiments where a first structural or sacrificial material is an HTED metal or alloy and thus is non-electrolytically deposited and a second structural or sacrificial material is electrolytically deposited and more particularly where the first material is selectively deposited.

FIG. 6B provides a block diagram of the major steps in a process according to a second group of embodiments where a first structural or sacrificial material is an HTED metal or alloy and is thus non-electrolytically deposited and a second structural or sacrificial material is electrolytically deposited and more particularly where the first material is blanket deposited to cover and fill voids in a masking material.

FIG. 6C provides a block diagram of the major steps in a process according to a second group of embodiments where a first structural or sacrificial material is and HTED metal or alloy and is thus non-electrolytically deposited and a second structural or sacrificial material is electrolytically deposited and more particularly where the first material is blanket deposited and is then patterned to form voids into which the second material can be deposited.

Third Group of Embodiments

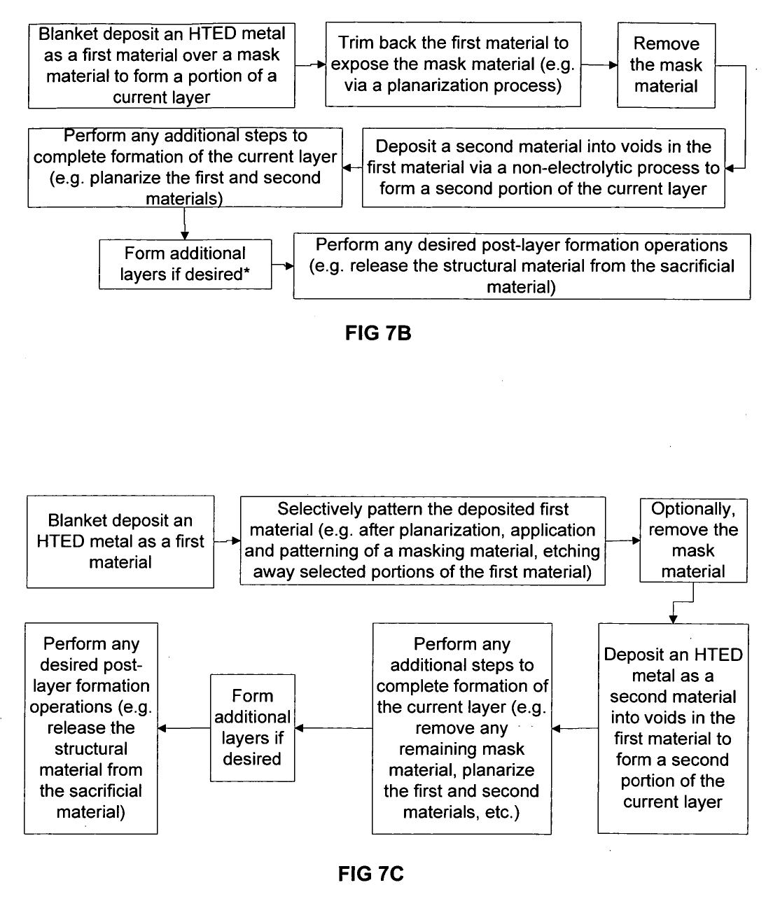

In a third group of embodiments, both the first and second materials are HTED metals or alloys and thus both materials are deposited in non-electrolytic manners. In this fourth group of embodiments, if the first material deposition operation may result in an over-coating of material on a masking or mold material. Prior to deposition of the second material, a planarization operation or lift off operation may be used to expose the masking or mold material which may then be removed. In some more specific embodiments in this fourth group, one of the non-electrolytically depositable materials set forth above is used as the first material to be deposited and its deposition occurs in one of the indicated manners while another of non-electrolytically depositable materials set forth above may be used as the second material. FIGS. 7A-7C provide block diagrams illustrating various example process flows according to this second group of embodiments.

FIG. 7A provides a block diagram of the major steps in a process according to a third group of embodiments which is similar to the process of FIG. 6A with the exception that the second material is also an HTED metal or alloy and is thus non-electrolytically deposited.

FIG. 7B provides a block diagram of the major steps in a process according to a third group of embodiments which is similar to the process of FIG. 6B with the exception that the second material is also an HTED metal or alloy and is thus non-electrolytically deposited.

FIG. 7C provides a block diagram of the major steps in a process according to a third group of embodiments which is similar to the process of FIG. 6C with the exception that the second material is also an HTED metal or alloy and is thus non-electrolytically deposited.

Fourth Group of Embodiments

In a fourth group of embodiments, three or more materials may be deposited with one or more of the materials being and HTED metal or alloy and thus not being deposited in an electrolytic manner. In some embodiments of the fourth group of embodiments, structural materials or sacrificial material materials other than HTED materials may be deposited in non-electrolytic processes. One or more additional planarization operations per layer may be required as described above in association with the second and fourth groups of embodiments. In this group of embodiments, one, more than one, or all deposited materials may be selected from the non-electrolytically deposited materials specifically set forth above.

FIG. 8 provides a block diagram of the major steps (along with various alternatives) in a process according to a fourth group of embodiments where the number of materials deposited per layer is variable. In practice at least one of the materials deposited on one or more layers is an HTED metal or alloy and is thus non-electrolytically deposited. Other processes according to the fourth group of embodiments are possible. For example, variations in the order of planarizing layers, removing masking material, and removing surface treatment materials are possible. In other variations, additional steps may be added to provide cleaning, additional patterning operations, deposition operations, surface activations, etching of blanket deposited materials and the like.

Specific Embodiments

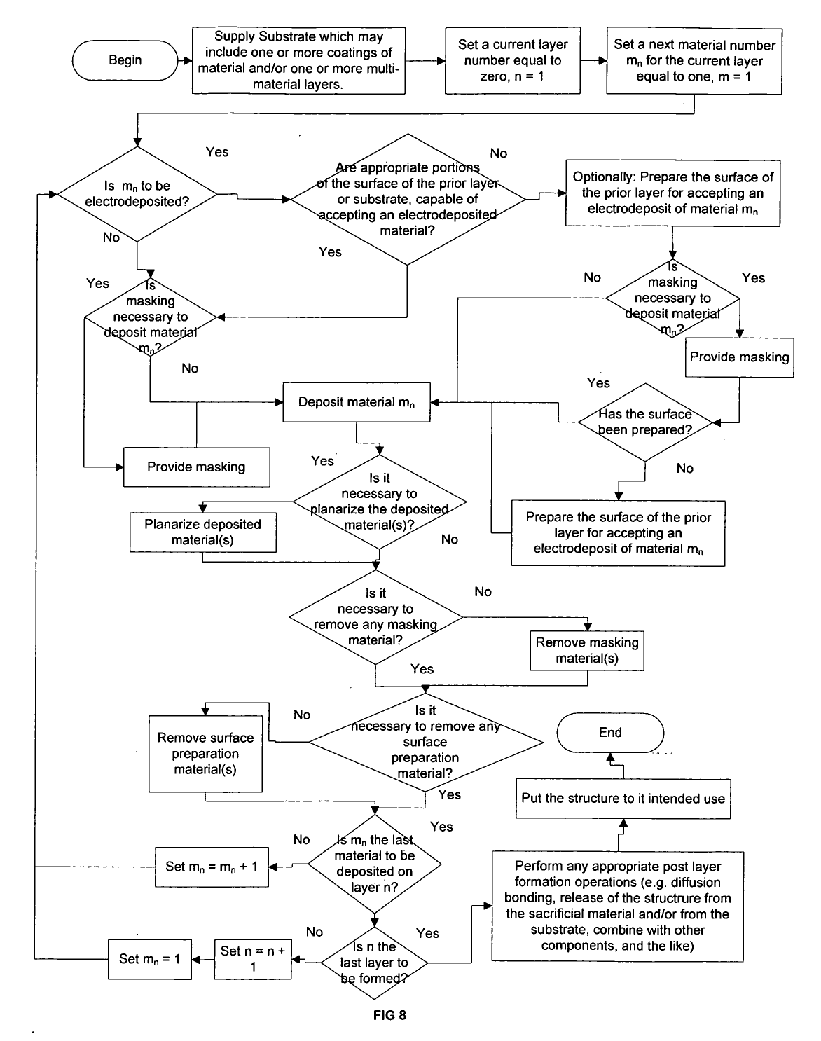

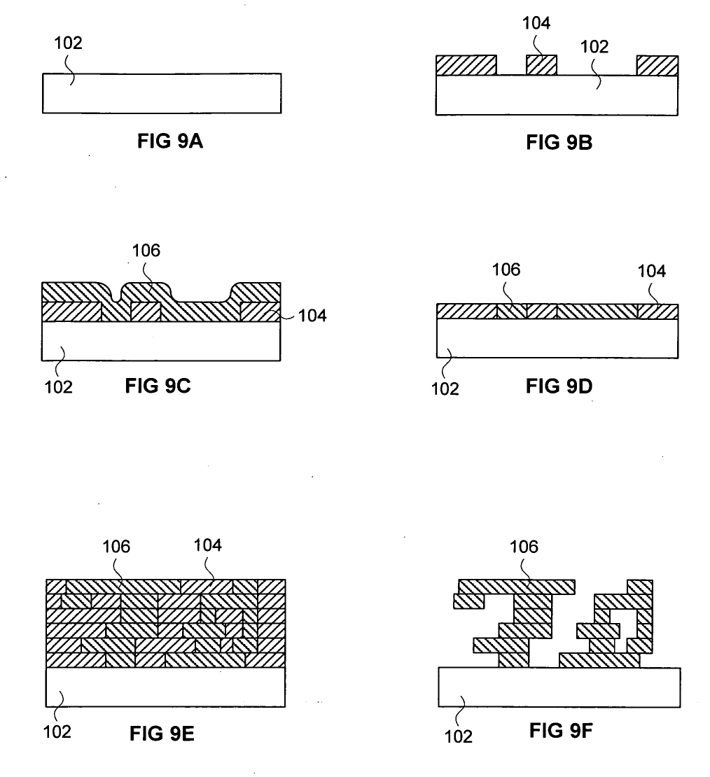

FIGS. 9A-9F depict schematic side views of various states of a first specific embodiment of the first group of embodiments as applied to an example structure, where the second material is an HTED metal or alloy and is thus deposited in a non-electrolytic manner. In FIG. 9(A), a suitable substrate 102 has been provided. In this embodiment, as well as in other embodiments, the substrate may be a dielectric (e.g. a ceramic or polymer) with or without a conductive seed layer deposited thereon or a conductive material (e.g. a metal) depending on the specific requirements of the material or materials to be deposited or on the processes used for their deposition or other process used in fabricating the structure. For example, if significant temperature differentials will exist during the fabrication process, then matching coefficients of thermal expansion as closely as possible between build materials and the substrate may be desirable.

In FIG. 9B, a first material 104 (as shown, the sacrificial material) has been selectively deposited (e.g., plated through a photoresist mask which has been removed) or alternatively, by wet or dry etching) to form the indicated example pattern.

In FIG. 9C, a second material 106 (in this example, the structural material) has been blanket-deposited by one method or another (e.g., sputtering). The second material adheres at least somewhat to the substrate (i.e. the original substrate or to a modified substrate (i.e. to a previously formed layer on the original substrate if the current layer is above the one or more previously formed layers). Adhesion between layers in this embodiment as well as in the other embodiments may be enhanced by diffusion bonding either on a layer-by-layer basis or after release from the sacrificial material.

In FIG. 9D, the two deposited materials have been planarized to yield a single layer of controlled thickness, flatness, and surface finish.

In FIG. 9E, the state of the process is shown after additional layers have been formed. These additional layers may be formed by repeating the operations exemplified in FIGS. 9B-9D a plurality of times or by exercise of one or more different processes. Each layer may have its own potentially unique (1) cross sectional configuration, (2) layer thickness, (3) choice of first and second materials, and (4) formation processes.

In FIG. 9F, the sacrificial material has been removed, for example by use of an etchant that minimally damages the structural material, yielding the final or released three-dimensional structure.

In this embodiment, as well as in other embodiments, additional operations may be performed during the layer-by-layer build up of the structure or before or after removal of sacrificial material. For example, additional operations may include: (1) cleaning operations, (2) activation operations, (3) annealing operations, (4) hardening operations, (5) conformable coating operations, (6) deposition of adhesion materials, seed layer materials, barrier materials, and the like. Additional post layer formation operations may include, for example releasing the structure from the substrate 102 and bonding it or otherwise mounting it on a different substrate, dicing a plurality of simultaneously formed structures one from another, packaging the structure in a hermetic package, forming electrical or mechanical connections to the structure.

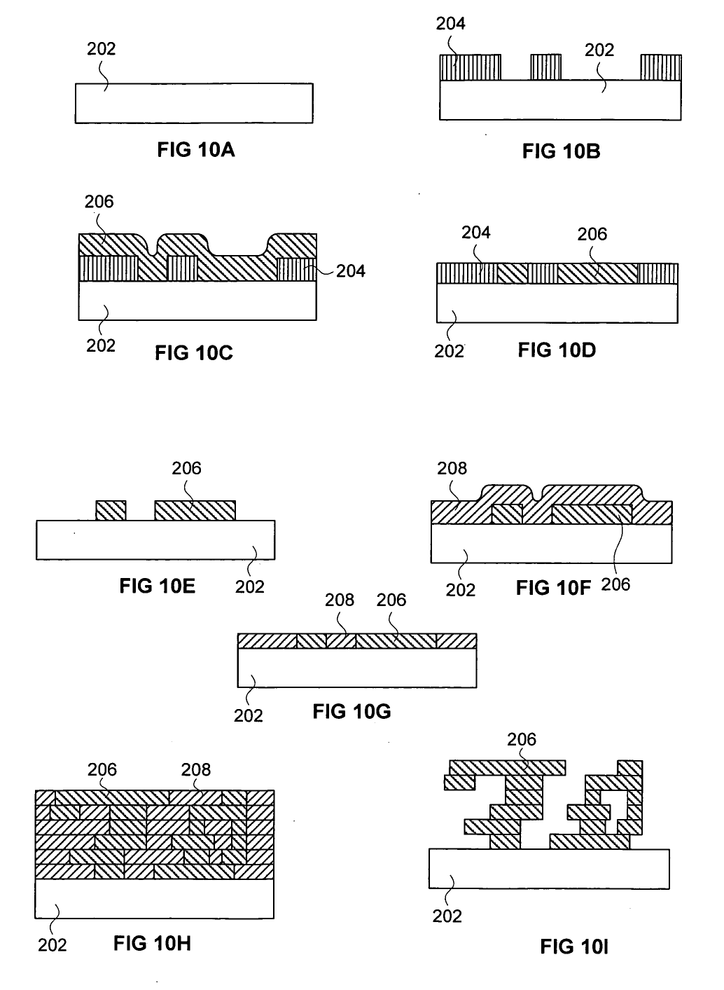

FIGS. 10A-10F depict schematic side views of various states of a more detailed example of the first specific embodiment of the second group of embodiments and in particular of the process of FIG. 6B as applied to an example structure, where the first material is an HTED metal or alloy and is thus a patterned via non-electrolytic deposition. The HTED material is deposited into a photoresist mold or mask that has been created over the surface of the substrate. FIG. 10A, shows the state of the process after a suitable substrate 202 has been provided.

FIG. 10B, depicts the state of the process after a masking material 204 (e.g., a planarizable photoresist, possible a fairly hard but removable resist such as SU-8 from MicroChem Inc., Newton, Mass.) has been deposited and patterned.

In FIG. 10C, a first material 206 (e.g. one of the materials set forth above) has been blanket-deposited by one method or another which cause not only deposition into opening in the masking material but above the masking material as well.

In FIG. 10D, the masking material and the deposited material have been planarized (e.g. via lapping or fly cutting, or the like) to expose the masking material so that is may be removed, as has shown in FIG. 10E.

In FIG. 10F, a second material 208 has been blanket-deposited.

In FIG. 10G, the first and second materials have been planarized to yield a single layer of controlled thickness, flatness, and surface finish. The planarization level achieved in FIG. 10G may be, and preferably is, less than that targeted in FIG. 10D.

In FIG. 10H additional layers are shown as having been formed. These additional layers may be formed by repeating the process exemplified in FIGS. 10B-10G a plurality of times or by exercises one or more different processes. Each of these additional layers may have its own (potentially) unique cross section, layer thickness, materials, and may involve different formation operations or orders of performing those operations.

In FIG. 10I, one material (the sacrificial material) is shown as having been removed, yielding the final structure. Due to the use of two planarization operations, it may be advantageous to use an initial masking material thickness that is considerably greater (e.g. 1.2-2.0, or more, times greater) than the final layer thickness required.

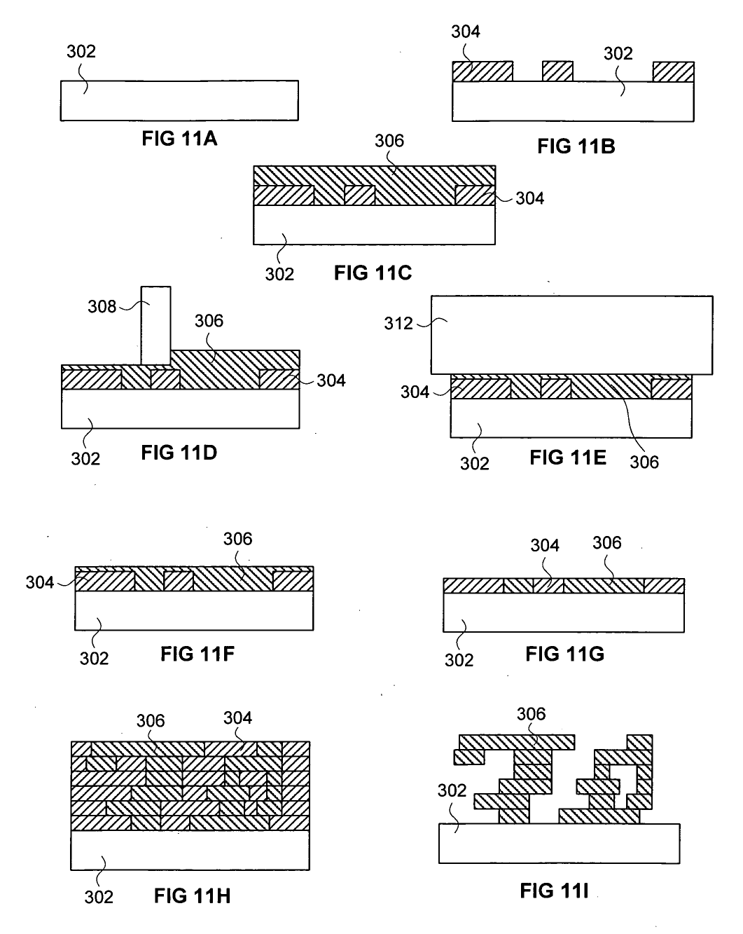

FIGS. 11A-11H depict schematic side views of various states of a second specific embodiment of the first group of embodiments where the second material is an HTED metal or alloy and is thus deposited in a non-electrolytic, flowable form (e.g., a liquid, a paste, or a powder nor requiring consolidation). Examples of useable second materials include molten metals and alloys; cast, sprayed, or dipped amorphous/glassy metals such as Liquidmetal® materials (from Liquidmetal Technologies, Lake Forest, Calif.). In FIG. 11A, a suitable substrate 302 has been provided.

In FIG. 11B, a first material 304 (as shown, the sacrificial material) has been electrolytically deposited and patterned. The process resulting in the change of state from FIG. 11A to FIG. 11B may take on a variety of forms. The process, for example may include (1) applying a masking material, (2) providing voids in the masking material, selectively depositing the first material, and (3) removing the masking material. As another example the process may include (1) blanket depositing the first material, (2) planarizing the first material, (3) applying and patterning a masking material on the first material, (4) etching into the first material via voids in the mask, and (5) removing the masking material. As a third example, the first material may be deposited in a direct write manner or some other maskless and selective deposition process.

In FIG. 11C, a second material 306 (in this example, the structural material and an HTED metal or alloy) has been blanket deposited in a non-electrolytic manner in the form of a liquid, paste, or powder. Since a relatively thin layer of material is deposited and the substrate (especially if metallic) or previous layer tends to be quite thermally-conductive, materials that might normally solidify with a crystalline microstructure may be induced to solidify as an amorphous material instead, which can benefit strength, hardness, corrosion resistance/biocompatibility, elasticity, etc.

In FIG. 11D, a doctor blade 308 (or other smoothing/trimming device, e.g. a counter rotating roller) is depicted as being used to remove excess flowable material. Alternatively or in addition to the doctor blade approach, a plate 312 pressed against the material can be used to remove excess material, as shown in FIG. 11E. The result of removing the excess flowable material is show in FIG. 11F.

Next (not shown), the material would typically be at least partially solidified (e.g., through cooling, thermal polymerization, radiation based polymerization, other curing, solvent evaporation, and the like). If such solidification is not required to allow planarization in the next step, the solidification operation may be skipped or delayed. If the material will undergo a shrinkage upon solidification, it may be desirable to ensure it has some excess thickness prior to solidification and planarization to accommodate for this shrinkage alternatively, after solidification the operations of FIGS. 11C-11F may be repeated to increase the height of the second material prior to considering the formation of the current layer to be completed.

In FIG. 11G, the two materials (i.e. the first and second materials) have been planarized to yield a completed layer. Depending on the materials involved, the level of accuracy required, and the surface finish required, the planarization process may take on a variety of forms. For example, planarization may occur via grinding, via single stage or multistage lapping, lapping and polishing, lapping followed by etching, lapping followed by etching and polishing, chemical mechanical polishing (CMP), fly cutting using a diamond tipped tool, and/or the like.

In FIG. 11H, the state of the process is shown after five additional layers have been formed either by repeating the process exemplified in FIGS. 11B-11G or by use of one or more other processes.

In FIG. 11I, the sacrificial material has been removed, yielding the final structure formed from a single structural material.

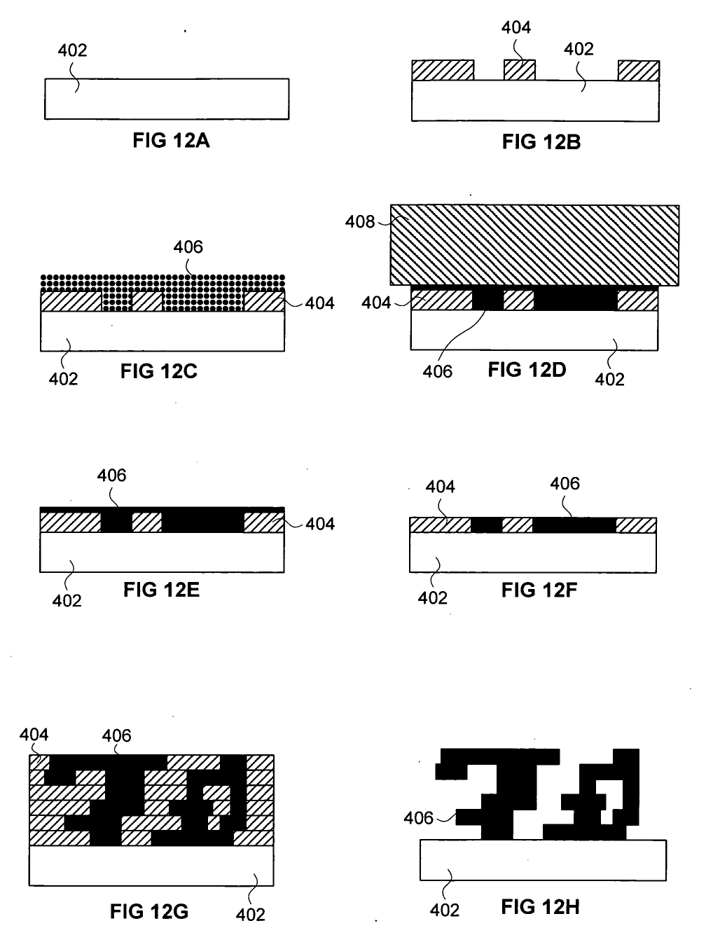

FIGS. 12A-12H depict schematic side views of various states of a third specific embodiment of the first group of embodiments where the first material is deposited electrolytically and the second material is an HTED metal or alloy and is deposited in a powder form that requires consolidation.

In FIG. 12A, the state of the process is shown after a suitable substrate 402 has been provided.

In FIG. 12B, a first material 404 (as shown, the sacrificial material) has been patterned (e.g. via selectively deposition, blanket deposition followed by selective removal, or blanket deposition over a masking material followed by removal of the masking material and any overlaying first material).

In FIG. 12C, a second material 406 (in this example, the structural material) in the form of a powder has been blanket-deposited. In this embodiment the powder is applied to a thickness that allows for shrinkage in volume as it is pressed and consolidated.

In FIG. 12D, a ram 408 capable of applying compressive pressure to the material is used to compress it. Not shown is an optional step to remove excess powder similar to those shown in FIGS. 11D and 11E. After consolidation, most or all of the void space between the powder particles may have been removed, forming a mostly non-porous mass. Alternatively, residual pores may remain, which may be infiltrated with the same or a different material before continuing further (e.g., on a layer-by-layer basis) or later, after release of sacrificial material. If desired; however, variations of this embodiment may be used to create a porous structure.

The result of compacting the material is show in FIG. 12E where material 406 has been converted into material 406′. In some alternative embodiments, instead of a ram, a flexible medium able to apply pressure could be used and cold or hot isostatic pressing used for the compaction. In some variations of this embodiment, compaction may cause consolidation of the particles into a cohesive mass while in other variations one or more additional processing steps may be used to consolidate the compacted particles. This additional step or steps may be dependent on the properties of the particles themselves. For example, particles that are formed from a meltable material or are coated with a meltable material may be converted via application of heat, whereas particles that are coated with a radiation curable material or volatile material may be consolidated by exposure to radiation or vacuum (i.e. to aid in removal of the volatile material). In still other variations, consolidation may occur by infiltrating the particles with a flowable binding agent or with a flowable filler material.

In FIG. 12F, the two materials are shown as having been planarized.

In FIG. 12G, the state of the process is shown after additional layers are formed. These additional layer may be formed by repeating the operations of FIGS. 12B-12F a plurality of times using appropriate materials and cross-sectional patterns or they may be formed using different process steps.

In FIG. 12H, the sacrificial material has been removed, yielding a structure which may be in final form, or it may be ready for further processing. For example, additional processing may include infiltrating pores in the structure with a filler material. Alternatively, the pores and voids can be removed by further heating or by cold or hot isostatic pressing. In an alternative to the embodiment of FIGS. 12A-12H, no compression may be performed but instead a process of filling pores may be used such as that described in U.S. patent application Ser. No. 10/697,597 entitled “EFAB Method and Appratus Including Spray Metal or Powder Coating Processes” or in U.S. Pat. No. 3,823,002, entitled “Precision Molded Refractory Articles,” issued July 1974 to Kirby et al.; U.S. Pat. No. 3,929,476, entitled “Precision Molded Refractory Articles and Method of Making,” issued December 1975 to Kirby et al.; U.S. Pat. No. 4,327,156, entitled “Infiltrated Powdered Metal Composites Article,” issued April 1982 to Dillon et al.; U.S. Pat. No. 4,373,127, entitled “EDM Electrodes,” issued February 1983 to Hasket et al.; U.S. Pat. No. 4,432,449, entitled “Infiltrated Molded Articles of Spherical Non-Refractory Metal Powders,” issued February 1984 to Dillon et al.; U.S. Pat. No. 4,455,354, entitled “Dimensionally-Controlled Cobalt Containing Precision Molded Metal Article,” issued June 1984 to Dillon et al.; U.S. Pat. No. 4,469,654, entitled “EDM Electrodes,” issued September 1984 to Hasket et al.; U.S. Pat. No. 4,491,558, entitled “Austenitic Manganese Steel Containing Composite Article,” issued January 1985, to Gardner; U.S. Pat. No. 4,554,218, entitled “Infiltrated Powdered Metal Composite Article,” issued November 1985, to Gardener et al.; U.S. Pat. No. 5,507,336, entitled “Method of Constructing Fully Dense Metal Molds and Parts,” issued to Tobin; or U.S. Pat. No. 6,224,816, entitled “Molding Method, Apparatus, and Device Including Use of Powder Metal Technology for Forming a Molding Tool with Thermal Control Elements”, issued May 2001, to Hull, et al. Each of these patent applications and patents is incorporated herein by reference.

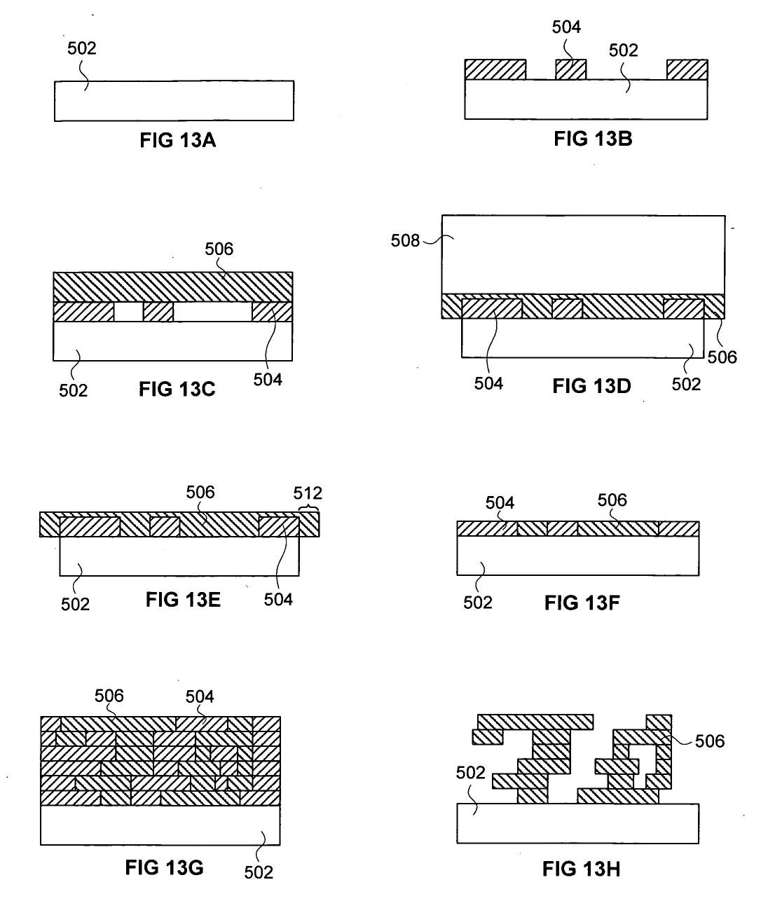

FIGS. 13A-13H depict schematic side views of various states of a fourth specific embodiment of the first group of embodiments as applied to a specific example structure where the second material is an HTED metal or alloy and is deposited in sheet form, then deformed mechanically, sonically, and/or thermally.

In FIG. 13A, the state of the process is shown after a suitable substrate 502 has been provided.

In FIG. 13B, the state of the process is shown after a first material 504 (as shown, the sacrificial material) has been patterned.

In FIG. 13C, a second material 506 (in this example, the structural material) in the form of a sheet has been laid on top of the partially formed layer (i.e. on top of the first material).

In FIG. 13D, a ram 508 capable of applying compressive pressure, heat, and/or sonic vibration to the material is used to deform it such that it flows into the apertures in the first material with minimal voids and adheres at least somewhat to the first deposited material and to the previous layer (or substrate), for example, by cold welding, diffusion bonding, or the like. In some variations of the embodiment, the compression may be performed under vacuum. Alternatively, instead of a ram, a flexible medium able to apply pressure could be used and cold or hot isostatic pressing used for the deformation.

The state of the process that after the deformation is completed is shown in FIG. 13E.

In FIG. 13F, the two materials have been planarized and excess squeezed-out material has been trimmed off if required.

In FIG. 13G, the state of the process is shown after formation of a plurality of additional layers. The additional layers may be formed via repetitions of the process exemplified in FIGS. 13B-13F or via some other process.

In FIG. 13H, the sacrificial material has been removed, yielding the final structure.

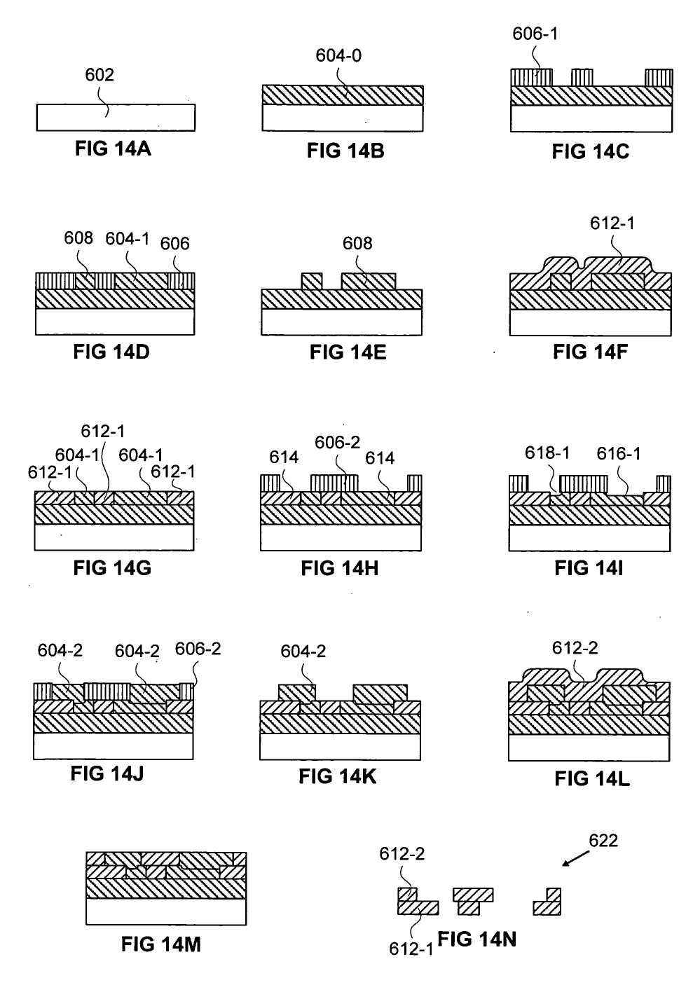

FIGS. 14A-14N depict various states of a process for forming a three-dimensional structure according to a fifth specific embodiment of the first group of embodiments of the invention in which multilayer structures of nickel titanium (NiTi), tantalum (Ta), or titanium (Ti) or other material (HTED metal) that is difficult to plate onto can be fabricated. In the remaining discussion of this embodiment, it will be assumed that NiTi is the structural material though it should be understood that it may be replaced with one of this other materials in variations of this embodiment. This embodiment uses anodic activation of NiTi located on an immediately preceding layer possibly in combination with other processes such as cathodic activation to prepare NiTi for receiving electrodeposited sacrificial metal (e.g. copper) with good adhesion during the formation of a current layer. FIGS. 14A-14N illustrate a process in which a NiTi structure is fabricated over a compound substrate that includes a sacrificial material located on a base substrate so as to enable ultimate separation of the structure from the base substrate. In variations of this embodiment structures may be built that adhere to a base substrate or to a compound substrate that includes a non-sacrificial coating (e.g., Au or Ni) on a base substrate.

FIG. 14A shows the state of the process after substrate 602 (more particularly a base substrate) is supplied. The substrate 602 may include one or more previously formed multi-material layers or single material coatings.

In FIG. 14B the state of the process is shown after a coating or mono-material layer of sacrificial material 604 (e.g. copper) has been deposited and planarized (if required).

In FIG. 14C the state of the process is shown after a photoresist 606-1 or other masking material has been deposited and patterned on sacrificial material 604-0 on substrate 602.

In FIG. 14D the state of the process is shown after a sacrificial material 608 (e.g. copper) has been selectively electrodeposited within voids or openings in the photoresist 606. Sacrificial material 604-1 may be different or the same as sacrificial material 604-0.

In FIG. 14E the state of the process is shown after the photoresist 606-1 has been removed.

In FIG. 14F the state of the process is shown after a structural material 612-1 (e.g. NiTi) has been blanket deposited.

In FIG. 14G, the first layer comprising both a sacrificial material and a structural material has been planarized. Since this first layer was not formed over a surface that was hard to plate onto, there was no need to take special steps to prepare the surface to be plated with sacrificial material. However, in general, the cross-sectional geometry of the second and subsequent layers will be such that sacrificial material needs to be deposited at least in part over underlying structural material (e.g. NiTi) which may require surface preparation. It is understood that the formation of some layers may involve sacrificial material being deposited over only sacrificial material on the previous layer and in such cases, when they are recognized or detected, it may be possible to forego any special surface preparation steps. It is also understood that the formation of some layers may involve sacrificial material being deposited over both sacrificial material and structural material but where the majority of the edges of sacrificial material only contact regions of sacrificial material and when such situations are recognized or detected, it may be possible to forego any special surface preparation steps.

In FIG. 14H the process is shown after preparation for forming a second layer on the first layer is initiated by the depositing and patterning of a photoresist 606-2. As shown in FIG. 14H, at least some of the openings 614 through the photoresist reveal exposed NiTi on the previous layer. Sacrificial material will be deposited into these openings. FIG. 14I shows the state of the process after a process of activating and preparing the surface of the previous layer has been performed. In variations of this embodiment, the activation comprises anodic activation followed immediately by cathodic activation, both in a 15% (volume) hydrochloric acid solution. When performing such activation, the use of noble metal electrodes (first as a cathode and then as an anode) such as platinum-coated titanium may be preferred. As examples, anodic (i.e., the wafer is the anode) and cathodic (i.e., the wafer is the cathode) current densities of 80 mA/cm² for one minute may be used for activation. When anodic activation is used, some dissolution 616-1 of the sacrificial material 604-1 may result as shown in FIG. 14I. Furthermore some undercutting 618-1 of the photoresist may occur. It is anticipated that little or none of the NiTi will be dissolved.

In FIG. 14J, sacrificial material 604-2 (e.g. Cu) for the second layer has been deposited (e.g., from an acid Cu plating bath at a current density of 20 mA/cm²) through the apertures of the photoresist. Ideally the sacrificial material is deposited as soon as possible after activating the surface to minimize the risk of re-oxidation (placing the wafer in an inert gas after activation may be useful in this regard).

In FIG. 14K the state of the process is shown after photoresist 606-2 has been stripped.

In FIG. 14L the state of the process is shown after the structural material 612-2 (e.g. NiTi) has been deposited.

In FIG. 14M the state of the process is shown after the planarization of the sacrificial material 606-2 and structural material 612-2 deposited in association with formation of the second layer has been planarized to complete formation of the second layer.

Finally, in FIG. 14N the structure 622 formed of structural material 612-1 and 612-2 has been released by etching away sacrificial materials 604-0, 604-1, and 604-2. In some variations of this embodiment the structural material deposited on each layer may be the same material while in other variations of the embodiment, the structural material deposited on one or more layers may be different from that deposited on one or more other layers. In some variations of this embodiment the sacrificial material 604-0 deposited on the base substrate and the sacrificial material 604-1 and 604-2 forming part of each layer may be the same material while in other variations of the embodiment, the sacrificial material deposited on the base substrate and/or on one or more layers may be different from that deposited on one or more other layers.

Bubbles produced during both cathodic and anodic activation in preparation for depositing sacrificial material in association with a current layer may get trapped in small openings in the photoresist, thus preventing the structural material on the previous layer from being properly activated in some areas. In some variations of this embodiment, the use of mechanical agitation of the activation bath, ultrasonic/megasonic agitation of the bath, vacuum or low-pressure degassing of the bath, and/or the addition of a surfactant to the bath may be used.

In some variations of this embodiment, different surface preparations (e.g., activation processes) may be used for different layers before depositing sacrificial material such as Cu. In other embodiments, surface activation may be used after deposition of the sacrificial material and prior to deposition of structural material to improve adhesion of the structural material on a current layer to that associated with the preceding layer or to improve electrical conductivity through structural material a crossed layer boundaries.

Some sacrificial material dissolution (e.g., FIG. 14I) during structural material activation prior to sacrificial material deposition may be acceptable since the sacrificial material that will be deposited after the activation (e.g., FIG. 14J) can fill in or substantially fill in any missing material. Depending on the geometry, however, the dissolution may be excessive. It can, for example, cause delamination of photoresist by undercutting photoresist that is mostly or completely supported by Cu. There may also be regions formed of undercut (e.g., larger than shown in FIG. 14I) that do not get sacrificial material plated back during the subsequent deposition because the photoresist overhangs, shadows, or masks the undercut region 618-1 too much. While some voids may be acceptable in the sacrificial material (e.g. as long as the sacrificial material is electrically continuous and mechanically strong), structural material may, in some cases, be deposited into the voids, forming a protruding defect on the underside of a structural feature. Therefore in some embodiments (e.g. during formation of selected layers), methods which reduce or eliminate sacrificial material dissolution may be used. In some such embodiments, anodic activation time or current density may be reduced, possibly with cathodic activation following the anodic activation and with the cathodic activation being applied for a longer time and/or at a higher current density. In some alternative embodiments, no anodic activation or a reduced amount of anodic activation may be used, with a copper strike performed after cathodic activation (e.g., in an HCl bath) instead.

In some other alternative embodiments, no anodic activation may be used or a reduced amount of anodic activation may be used, with a nickel strike performed after cathodic activation. Although the biocompatibility of nickel for medical device applications may be less than desirable, the amount of nickel that is used is small. Moreover, in some such embodiments, before (or preferably, after) release of sacrificial material, heat treatment of the structure will cause the thin nickel and the NiTi (or other structural material) to inter-diffuse, reducing-or eliminating the quantity of pure Ni that is present in the final product. Heat treatment is generally desired in any case to transform sputtered amorphous NiTi into its crystalline form, and in some embodiments the two results may be achieved during the same heat-treatment process.

In the case of building structures with Tantalum (Ta) as a structural material, hydrofluoric acid (HF) may be used by itself to remove Ta oxide in preparation for plating sacrificial material such as Cu. In some embodiments, application of HF followed by a strike (nickel or copper) may be used. In some embodiments, HF may be used as the bath in which anodic and/or cathodic activation, either with or without a nickel or copper strike, may be performed.

In some alternative embodiments, to minimize risk of sacrificial material dissolution, the previous layer may be patterned (e.g., with photoresist) so that only those regions of structural material (e.g. NiTi) that are to be plated with sacrificial material during formation of a current layer are exposed to the electrochemical activation treatment.

In still other embodiments, the structural material (e.g. NiTi) may be coated with a material that can be electroplated onto. This coating may occur via a vacuum deposition process. In some embodiments, this material is the one of the sacrificial materials used to in fabricating layers. In others, it is a different sacrificial material which is either removed by a similar process as that used to remove the primary sacrificial material, or by a different process. In others, it is a non-sacrificial material that remains and is acceptable as part of the final structure (e.g., for some applications it may need to be biocompatible).

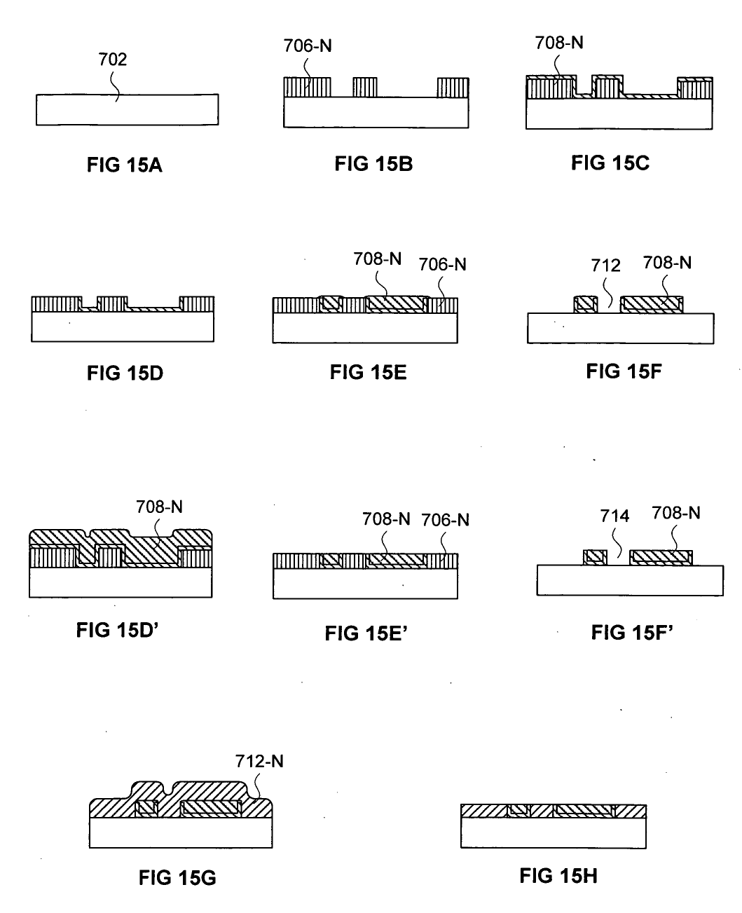

FIGS. 15A-15H depict various states of a process for forming a three-dimensional structure according to a sixth specific embodiment of the first group of embodiments of the invention in which a coating of the sacrificial material to be electrodeposited over a previously formed layer that contains or may contain a structural material that is hard to electroplate over (i.e. an HTED metal, e.g. NiTi) is first applied using vacuum processing and then increased in height via electroplating.

FIG. 15A depicts the state of the process after partial formation of a structure 702. That is FIG. 15A depicts the state of the process after one or more multi-material layers 702 comprising a partially formed structure have been formed on a substrate where the most recently formed layer includes a structural material that is difficult to electroplate over. In this embodiment, it is assumed that layers 1 to N-1 have already been formed as part of partially formed structure 702 and that the next layer to be formed is layer N.

FIG. 15B depicts the state of the process after a masking material 706-N (e.g., photoresist) has been deposited and patterned onto the previously formed layers 702 of the partially formed structure. The masking material 706-N is preferably is of a kind that can be processed to yield vertical sidewalls.

In FIG. 15C, a first material (e.g., Cu) 708-N has been vacuum deposited (e.g., by sputtering or evaporation) onto the previously formed layers 702 and over the masking material to form a thin portion of the Nth layer. This vacuum-deposited material can adhere well to the structural material (e.g. NiTi) or materials and sacrificial material or materials forming part of the previously formed layer. Adhesion, and potentially conductivity, can be enhanced further by performing a plasma etch, back sputtering, or other treatment to remove any oxide layer prior to the vacuum deposition of first material 708-N process. Any such treatment is preferably followed by deposition without breaking vacuum in the deposition chamber. However, if desired, an adhesion film (not shown) can be deposited prior to the vacuum deposition of the first material 708-N, preferably without breaking vacuum, and preferably of a material (e.g., TiW) that can be removed using the same etchant as is used to remove the sacrificial material (e.g., Cu).

FIGS. 15D-15F and FIGS. 15D′-15F′ illustrate two alternative sequences of steps that may be carried out after vacuum depositing the first material 608-N.

FIG. 15D depicts the state of the process after the first material 708-N overlying the masking material has been removed (e.g., by planarization, possibly using diamond machining), leaving behind a thickness sufficient to allow for an additional planarization step later. This removal step exposes the top surface of the masking material 706-N, allowing for removal of this material later.

FIG. 15E depicts the state of the process after a relatively thick deposit of the first material 608-N via electrodeposition (e.g. having a thickness that yields a total deposition height greater than the final layer thickness desired for the Nth layer). In some alternative embodiments this material may be different from the vacuum deposited material. In this embodiment, it is presumed that the previous layer is conductive. In variations of this embodiment, if the previously layer is not conductive, it may be made conductive by deposition of a conductive coating material or materials (e.g., Ti/Au).

FIG. 15F depicts the state of the process after the masking material 706-N has been removed (e.g., by chemical stripping).

FIG. 15D′ depicts the state of the process, along an alternative process branch, after a relatively thick deposit of the first material 708-N has been deposited to a depth typically in excess of the final layer thickness for the Nth layer. Although the previous layer may be conductive, this is not required since the vacuum-deposited first material forms a continuous plating base.

FIG. 15E′ depicts the state of the process after the vacuum deposited first material 708-N, the electrodeposited first material 708-N, and the masking material 706-N have been planarized (e.g., by diamond machining), leaving behind a thickness typically sufficient to allow for an additional planarization step later that will set the boundary level/height of the Nth layer. This planarization step exposes the top surface of the masking material, allowing removal (e.g., by chemical stripping) as shown in FIG. 15F′.

FIG. 15G depicts the state of the process after the second material 712-N, i.e. the structural material (e.g. NiTi), has been blanket-deposited filling in the voids apertures 714-N in the first material.

FIG. 15H depicts the state of the process after the second material 712-N, the layer has been planarized to yield the desired thickness, planarity, and surface finish. Planarization may for example occur via diamond fly cutting, lapping, a combination of mechanical trimming and polishing, along with chemical etching, and the like. The steps shown in FIGS. 15B-15H can be repeated, with different patterns on each layer if desired, or other layer forming operations may be performed to add additional layers above layer N so as to build up a multi-layer structure from one ore more structural materials and with supporting sacrificial material that will eventually be removed.

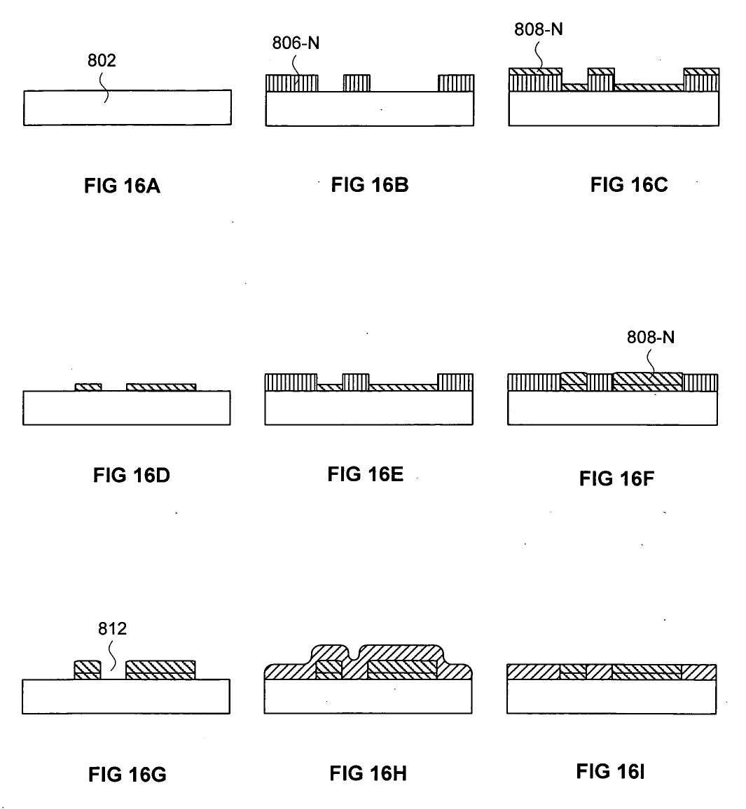

FIGS. 16A-16I depict various states of a process for forming a three-dimensional structure according to a seventh specific embodiment of the first group of embodiments of the invention in which a coating of the sacrificial material, to be electrodeposited, over a previously formed layer that contains or may contain a structural material that is hard to electroplate over (i.e. an HTED metal, e.g. NiTi) is first applied to selected portions of a previously formed layer via voids in a masking material and prior to thickening the coating of the first material, a lift off process is used to remove the vacuum deposited material from above the masking material.

FIG. 16A depicts the state of the process after a partially formed structure 802 is created and supplied for further processing. In this embodiment, it is assumed that layers 1 to N-1 have already been formed as part of partially formed structure 802 and that the next layer to be formed is layer N.

FIG. 16B depicts the state of the process after a masking material 806-N (e.g., photoresist) has been deposited and patterned onto the provided partially formed structure 802. The masking material is preferably of a type that provides an undercut sidewall geometry (not shown) when processed appropriately, and may be quite thin (the figure is not to scale). As before, removal of any oxide by plasma, back sputtering, or chemical cleaning, for example, may be done prior to vacuum deposition of the first material

FIG. 16C depicts the state of the process after a first material 808-N (i.e. a sacrificial material, e.g., Cu) has been vacuum deposited using a directional deposition process such as evaporation) onto the previous layer and over the masking material. If desired, an adhesion layer such as TiW can be deposited prior to the deposition of the first material 808-N and after any treatment process. Because of the undercut geometry of the masking material, the deposited material first material 808-N does not completely coat the sidewalls of the masking material.

FIG. 16D depicts the state of the process after the masking material has been stripped via a lift off process along with that portion of the first material 808-N that overlaid it. After the lift off process the only regions of first material remaining on the Nth layer are those regions where the first material was deposited directly onto the partially formed structure 802.

FIG. 16E depicts the state of the process after another masking material 816-N has been deposited and patterned in substantially the same pattern as the initial masking material 806-N. This masking material, however, preferably is of a kind that can be processed to yield vertical sidewalls.

FIG. 16F depicts the state of the process after a relatively thick deposit of the first material 808-N has been deposited to a depth in excess of the final layer thickness desired.

FIG. 16G depicts the state of the process after the masking material 816-N has been removed (e.g., by chemical stripping).

FIG. 16H depicts the state of the process after a second material (i.e. a structural material, e.g. NiTi) has been blanket-deposited, filling in the apertures 812 in the first material where masking material 806-N and 816-N were previously located.

FIG. 16I depicts the state of the process after the deposits made in association with the Nth layer have been planarized to set the boundary of the Nth layer at a desired thickness, planarity, and surface finish. The steps shown in FIGS. 16B-16J can be repeated, with different patterns on each layer if desired, or other layer forming operations may be performed to add additional layers above layer N so as to build up a multi-layer structure from one or more structural materials and with supporting sacrificial material that will eventually be removed.

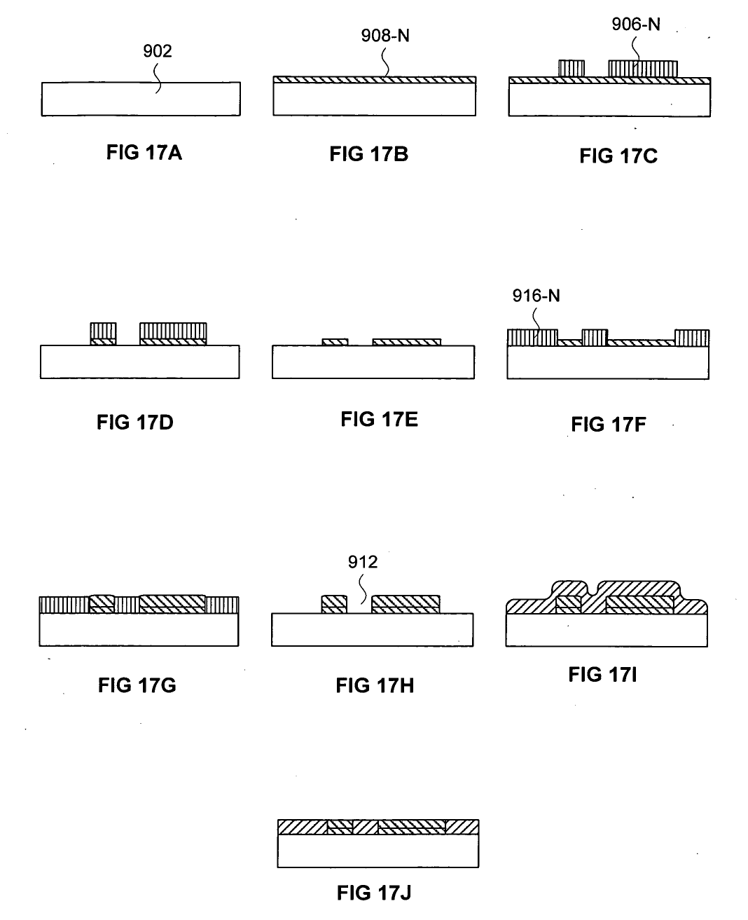

FIGS. 17A-17J depict various states of a process for forming a three-dimensional structure according to an eighth specific embodiment of the first group of embodiments of the invention in which a coating of the sacrificial material, to be electrodeposited, over a previously formed layer that contains or may contain a structural material that is hard to electroplate over (i.e. an HTED metal, e.g. NiTi) is first applied over the entire previous layer via a blanket vacuum deposition after which masking material is applied and the material patterned via etching.

FIG. 17A depicts the state of the process after a partially formed structure 902 is supplied. In this embodiment, it is assumed that layers 1 to N-1 have already been formed as part of partially formed structure 902 and that the next layer to be formed is layer N. As discussed above with regard to the embodiments of FIGS. 15A-15H and 16A-16I, before vacuum deposition of the first material 908-N, removal of any oxide on the previously formed layer, and more particularly from structural material on the previously formed layer, may occur via plasma etching, back sputtering, or chemical cleaning, or the like.

FIG. 17B depicts the state of the process after a first material 908-N (e.g., Cu) has been vacuum deposited onto the previous layer (i.e. layer N-1). If desired, an adhesion layer such as TiW can be deposited prior to the vacuum deposition of material 908-N.

FIG. 17C depicts the state of the process after a masking material 906-N (e.g., photoresist) has been deposited and patterned onto the previous layer.

FIG. 17D, depicts the state of the process after the first material (and the adhesion layer, if any) has been selectively etched using the masking material as a mask, resulting in a patterned film of first material (In FIG. 17E) overlaying regions where sacrificial material for layer N is to be located. In variations of this embodiment, the vacuum deposited material need only remain in those regions where sacrificial material overlays structural material that is hard to plate on that is located on layer N-1.

FIG. 17F depicts the state of the process after another masking material 916-N has been deposited and patterned. This material is preferably is of a kind that can be processed to yield vertical sidewalls. This material is patterned to locate openings over locations where sacrificial material 908-2 is to be thickened.

FIG. 17G depicts the state of the process after a relatively thick deposit of the first material 908-N has been deposited to a depth in excess of the final desired layer thickness.

FIG. 17H depicts the state of the process after, the masking material 916-N has been removed (e.g., by chemical stripping).

FIG. 171 depicts the state of the process after a second material (i.e. structural material, e.g. NiTi) has been blanket-deposited, filling in the apertures 912 in the first material 908-N.

FIG. 17J depicts the state of the process after the layer has been planarized to yield the desired thickness, planarity, and surface finish. The steps shown in FIGS. 17B-17J can be repeated, with different patterns on each layer if desired, or other layer forming operations may be performed to add additional layers above layer N so as to build up a multi-layer structure from one or more structural materials and with supporting sacrificial material that will eventually be removed.

Additional Embodiments

Though the specific embodiments addressed explicitly herein have focused primarily on the first group of embodiments, it will be clear to those of skill in the art that these embodiments may be modified or combined to derive new embodiments within the first group of embodiments as well as to derive specific embodiments that fall within the second through fifth groups of embodiments. For example, when the second material to be deposited on a given layer is to be electrodeposited while the first material to be deposited on the layer is an HTED material, preparation of the surface of the previously formed layer for receiving the electrodeposition of the second material may be delay until after deposition of the HTED material. Sputtered seed layer deposition may occur in a planar manner prior to deposition of the HTED material or in a non-planar manner such that it overlaying the HTED material as well as coating exposed regions of the last formed layer.

Though the embodiments have been described using the terms first and second materials, it should be understood that these materials do not necessarily have to be the first and second materials deposited on a layer or even consecutively deposited materials. In absence of other limiting features, the terms first and second should be considered to only imply that the first material was deposited prior to the deposition of the second material.

In the first through fourth groups of embodiments noted above, the first material may be a sacrificial material and the second material may be a structural material while in other embodiments, the first material may be a structural material and the second material may be a sacrificial material, while in still further alternative embodiments, both materials may be retained as structural materials. In the fifth group of embodiments, one or more materials may be structural material with any remaining materials being a sacrificial material.

In variations of the above noted groups of embodiments and specific embodiments where one material is to be deposited by electrolytic deposition, a seed layer (i.e. coating) and possibly an adhesion layer (i.e. coating) may be applied to an existing base (i.e. a previously formed layer, substrate, or previously deposited material forming part of the current layer) if the base is not sufficiently conductive to allow electrodeposition onto it or to which adhesion of the electrolytically deposited material is not adequate. Coatings may also be used to provide a barrier between two materials in case they are incompatible, would form undesirable intermetallic compounds, etc. Also, coatings in the form of a thin ‘strike’ may be used to facilitate electrodeposition of subsequent thicker deposits. The strike material may preferably, but not necessarily, be of the same material that will be thickly deposited over it.

Certain materials (typically structural materials) may benefit from cold working or similar mechanical action to improve properties such as strength. This can be achieved on a layer-by-layer basis by applying mechanical force (e.g., compressive force) to the material either after deposition or after planarization, or can be achieved after all layers are formed, either before or after release of sacrificial material. To facilitate the applying this force on a layer-by-layer basis, it may be advantageous to first partly planarize the layer (e.g. at a height that is above the desired layer boundary level), then apply the force, then finalize the planarization to achieve the final layer thickness, flatness, and/or surface finish (i.e. to set achieve the desired boundary level between the current layer and a subsequent layer to be formed). To allow for the effects of this force on layer thickness or topography, a thicker-than-normal deposit may be provided, with any excess removed through planarization. Also, since the force may cause features to widen or narrow compared with their intended dimensions, these dimensions can be precompensated in the original design or otherwise, to allow for this. Furthermore, if the sidewall angle of the layers is distorted by the force, this too may be precompensated, e.g., during the lithography stage, by tailoring the sidewall angle of the photoresist or similar material. The force may be provided by static pressure (e.g., contact with high-pressure ram or rollers) or by impact (shot peening, tumbling in a barrel with appropriate media, sandblasting, fluid jet, etc.). Layers deposited early in the build process (i.e., lower layers) may need less working than layers deposited later (i.e., upper layers) since they may be worked somewhat when the later layers are worked, by transmission of force through the upper layers. In some embodiments, heat treatment may be performed after the cold working is performed.

Prior to the deposition step shown in FIGS. 9B and 10B and especially if this deposition is by electrolytic means, it may be necessary to condition the surface of the previous layer to allow for satisfactory adhesion. Similarly, prior to the deposition steps of FIGS. 9C and 10C, conditioning of the previous layer may be needed. Such conditioning may involve electrolytic or chemical removal of oxide films, cleaning, degreasing, activation, etc. It may be important that the conditioning process does not degrade or damage the surface of other materials (e.g., the sacrificial material) that may be on the previous layer.

In some specific variations of the process exemplified in FIG. 9A-9F the first material deposited is the sacrificial material and includes Cu, Sn, of Zn while the second material is the structural material that is supplied via sputtering and includes nickel titanium (NiTi). In another specific variation of the embodiment exemplified in FIGS. 9A-9F, the first material is the sacrificial material which is electrolytically deposited Cu, Sn, or Zn while the second material is the structural material that is deposited via chemical vapor deposition (CVD) or chemical vapor-infiltrated deposition and include tantalum (Ta). In still another specific variation of the embodiment exemplified in FIGS. 9A-9F, the first material is the sacrificial material and includes Cu, Sn, or Zn while the second material is the structural material which is deposited via casting and includes Mg. In still other specific variations of the embodiment exemplified in FIGS. 9A-9F Ta, Fe, Mo, or stainless steel may be used as sacrificial materials.

In specific variations of the other embodiments and groups of embodiments set forth above, the specific variations discussed with reference to FIGS. 9A-9F may be implemented, mutatis mutandis.

In some embodiments, the aspect ratio (height/width) of apertures in the first (patterned) material may need to be kept below a particular value (e.g. height to width <1 or 1.5), and the minimum width of apertures may need to be kept above a particular value (e.g. width >5, 10, 20, or even 50 microns), such that voids are not produced in the second material. For PVD and possibly CVD deposition, rotating the substrate (e.g., about one or more axes that are parallel to the front surface of the substrate) may be useful in allowing an increase in aspect ratio or a decrease in minimum width.

In some embodiments, the first (patterned) material may need special characteristics to be compatible with subsequent processing, such as mechanical strength (e.g., for the methods shown in FIGS. 12A-12H or 13A-13H), temperature stability, and/or high-temperature oxidation resistance (e.g., for the method shown in FIG. 11A-11H). In other embodiments, the first and/or second material may need to have coefficients of thermal expansion matched closely to one another and/or to the substrate particularly when substrate area become large and more particularly when length of structural material regions become large. In some embodiments, it may be desirable to form lanes (e.g. dicing lanes, which may or may not be eventually diced) that separate individual die where the lanes are filled with structural material (e.g. Ta) or left free of material to minimize stress induced by the sacrificial material during temperature variations that may occur during processing (e.g. when cooling down from an 800° C. Ta deposition process). Lanes may be left free of material by use of shielding (e.g. shadow masks that are laid above openings in a first deposited material) to inhibit material deposition followed by a lift off operation if necessary to remove the shielding.

In many embodiments, the substrate may include a release layer (e.g. a first layer or coating deposited on an initial substrate may be formed completely from a sacrificial material) so that a permanent or initial part of the substrate may be separated from structural material that is deposited during the formation of layers. Alternatively, the entire substrate may be formed from a sacrificial material that can be removed. This may be desirable for applications where free structures are needed.

In the various embodiments, the one or more structural materials and one or more sacrificial materials should be selected such that they are compatible. For example, the sacrificial material may be selected so it can be removed (e.g., by chemical etching or melting) with respect to the structural material with little or no degradation of the latter. The two materials may be selected so that they can be co-planarized with minimal recession, dishing, smearing, etc. of one material with respect to another during selected planarization operations. Also, the two materials may (unless this is desired) be selected so that they do not form intermetallic compounds at their mutual interface.

Additional Teachings:

Thermal Processing:

Thermal processing of structures produced by some embodiments of the invention may be needed or desired. For example, diffusion bonding or other forms of heating, including low-temperature heating may be used to enhance inter-layer adhesion as already noted. Some materials may require heat treatment-to obtain the desired properties. For example, NiTi is deposited by sputtering typically in an amorphous form and requires heat treatment to transform it into a crystalline form. Heat treatment may be used to simultaneously enhance inter-layer adhesion and transform sputtered NiTi into a crystalline form. Prolonged heat treatment, beyond what is normally required to transform amorphous material, may be used to provide additional inter-layer strength. Heat treatment may also be used to diffusion bond together separately-fabricated components of a device, in combination with transforming the components from an amorphous to a crystalline state. Heat treatment may also be used to set the shape of a shape memory alloy such as NiTi, or adjust the transition temperature. In all such cases where thermal processing is needed, it may be preferable to release the structure (i.e., remove the sacrificial material from the structural material) and/or separate the structure from the substrate on which it is built, prior to thermal processing, to avoid distortion and damage due to differences in the coefficients of thermal expansion between different materials.

Preparing Oxidized Surfaces for Sacrificial Material Plating

NiTi (e.g., Nitinol) is a biocompatible, non-magnetic metal alloy that, depending on composition, can exhibit superelastic and shape memory properties that make it useful for many applications (including medical devices) as a structural material for the EFAB® microfabrication technology. However, it has a stable (titanium) oxide layer on its surface, which makes it a challenge to achieve good adhesion when depositing a sacrificial material such as Cu on top of NiTi on a previous layer, as is generally required when building multi-layer structures. Similar problems may be found with other materials such as Ta and Ti, and the methods of this invention are applicable to them as well.

To obtain good adhesion between an electrodeposited material and NiTi on the previous layer, the NiTi may be pretreated in some embodiments using electrochemical activation so that the surfaces to be plated are clean and active prior to electrodeposition. Adhesion of a sacrificial metal (e.g. copper) to structural metal (NiTi) need not be extremely good, but generally needs to be good enough that no delamination of material occurs during wafer processing, such as during planarization when the material is subject to mechanical forces.

Sputtering of Materials

When depositing materials (e.g., NiTi) in a vacuum chamber using processes such as sputtering, it may be important to mask off certain areas of the wafer, especially if the material is to be deposited in a selective fashion. For example, pads on the wafer surface may be provided for making measurements associated with endpointing of the planarization process. More information about such pads and measurement processes can be found in U.S. patent application Ser. No. 11/029,220, filed Jan. 3, 2005, by Frodis et al., and entitled “Method and Apparatus for Maintaining Parallelism of Layers and/or Achieving Desired Thickness of Layers During the Electrochemical Fabrication of Structures”. This referenced application is incorporated herein by reference as if set forth in full herein.

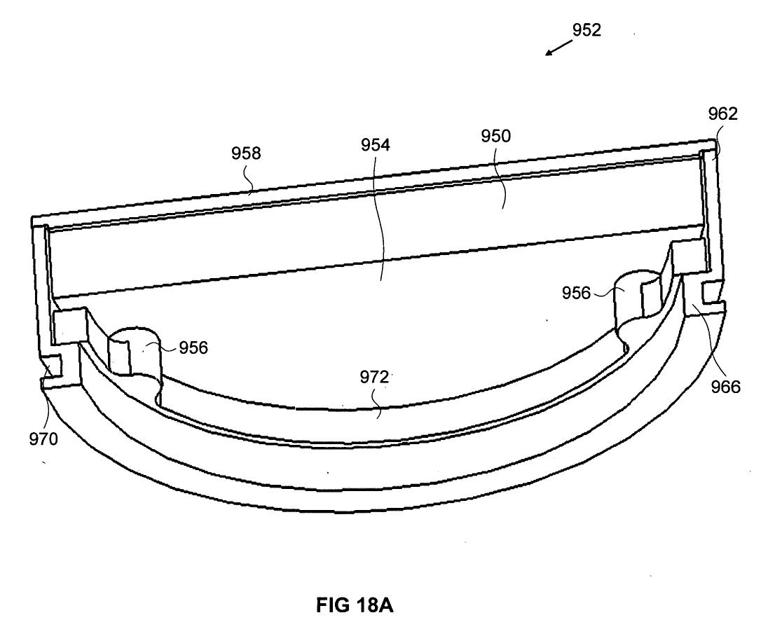

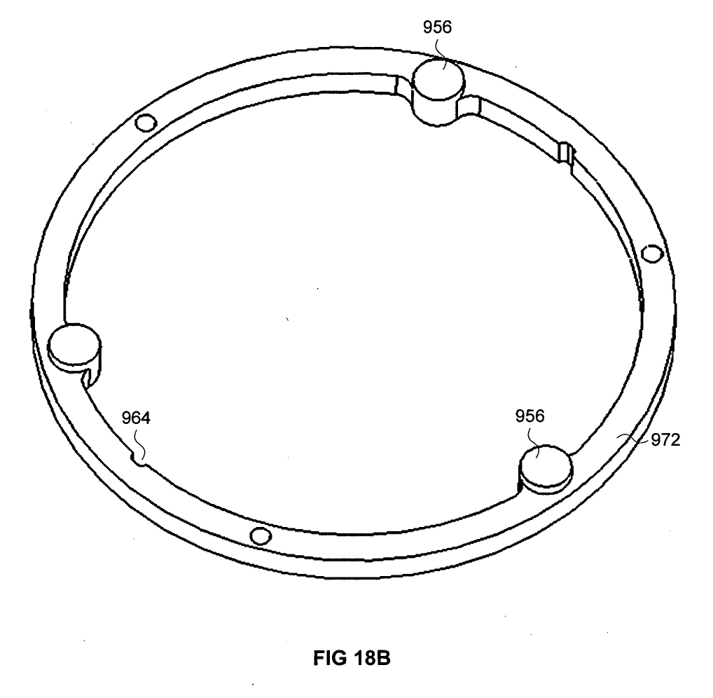

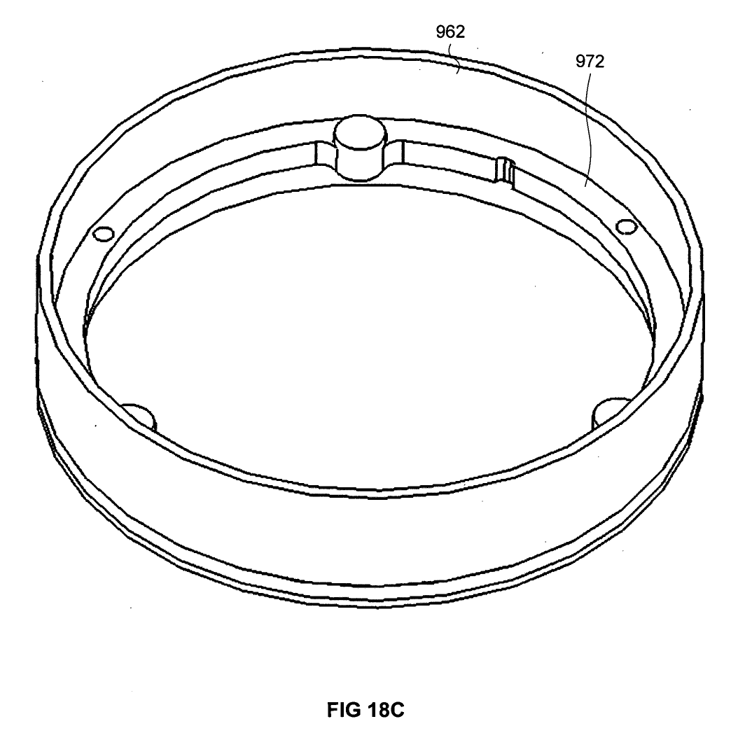

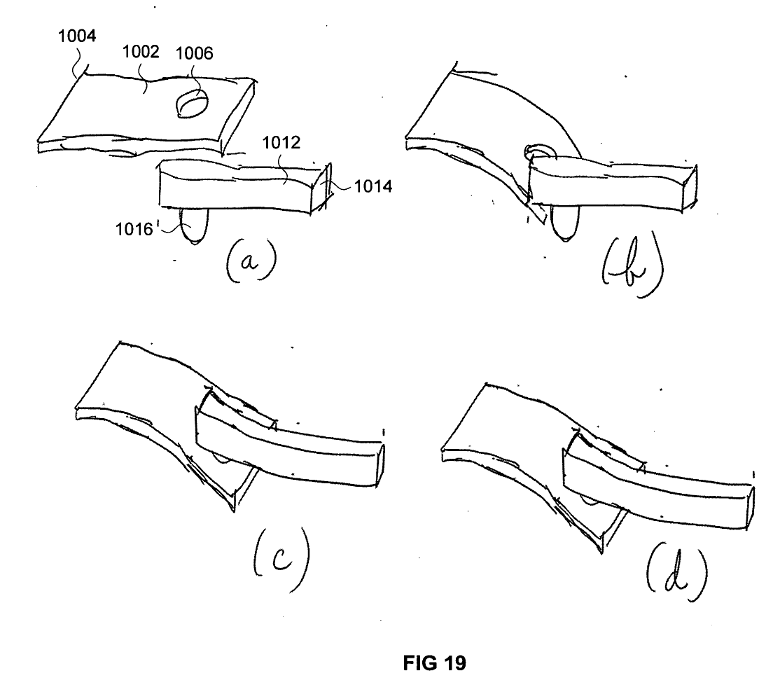

FIG. 18A provides a cut perspective view of a fixture 952 that includes a can-like structure 962 and a masking ring structure 972. The can-like structure may include a lid 958, a ledge 966 for supporting the masking ring, and one or more handling grooves 970. The fixture and more particularly the masking ring is intended to mask endpointing pads on the wafer 950 (i.e. a substrate and deposited layers of structural and sacrificial material) during vacuum deposition. FIG. 18B provides a perspective view of the masking ring 972 with pad masking surfaces 956 and cutouts 964 for exposing alignment targets. FIG. 18C provides a perspective view of the can 962 and masking ring 972 without the wafer 950 in place. In this case, three pad-masking surfaces 956 are provided, one for each of three endpointing pads. The overall structure of the fixture is that of a ring with the pad-masking surfaces 956 protruding inward from the ring surface by an amount sufficient to allow deposition onto the wafer in the area of the ring other than where the pad-masking surfaces are in contact or near-contact. The ring may include features such as cutouts 964 to enhance deposition in certain features (e.g. alignment targets) where it might otherwise be less reliable. The fixture 952 may be used underneath a wafer 950 which is placed so that the surface 954 to be deposited onto is face-down (as shown in FIG. 18A); alternatively, the ring may be placed on top of a wafer whose surface to be deposited onto is face-up. Of course other orientations during deposition are also possible. Alignment between the areas of the wafer to be masked and the masking surfaces on the fixture may be achieved visually, through the use of pins or other mechanical elements, a flat or flats located on the side of the wafer and on the inside of the fixture so that only appropriate loading is possible. In some embodiments, a mechanism such as a clamp, screws, etc. (not shown) may be provided to hold the fixture in precise relationship to the wafer once aligned. The fixture is preferably made from a metal or other material that can tolerate the temperatures associated with the deposition process, and which does not outgas or otherwise contaminate the deposition process.

When depositing material in a vacuum chamber, it may also be desirable to avoid deposition on surfaces of the wafer other than the surface onto which layers are formed. For example, deposition onto the backside of a wafer may interfere, if it is not sufficiently uniform or too coarse in texture, with reliable holding of the wafer with a vacuum chuck. In such cases (as seen in FIG. 18A), the fixture may include a backside lid 958. In other words the wafer may be placed within a can-like fixture of suitable material which masks off the surfaces which are not to be deposited onto. The can may include the masking ring described above as an integral part thereof; the ring may be separate from the can and may be supported by a ledge or other structure within the can.

When depositing material in a vacuum chamber (e.g., sputtering NiTi), it may in some cases be necessary to stop the deposition process to allow the wafer to cool down. In some embodiments, the wafer may be placed in intimate contact with a chuck made of a material (e.g., Cu) that has high thermal conductivity and preferably with a large thermal mass so as to draw heat away from the wafer. The chuck may also be provided with cooling channels (not shown) through which a cooling fluid is passed.

Seam Elimination

When depositing materials that create grain structures (e.g. NiTi) using certain physical vapor deposition (e.g., sputtering) or chemical vapor deposition processes over topography associated with a previously-deposited patterned first (e.g., sacrificial) material, a ‘seam’ may form, and be seen, in the deposited material. The seam typically is offset inwards from, and follows, the edges of features. Since on each layer deposited material is sputtered into a cavity formed by previously-deposited sacrificial material, seams may be produced at the discontinuity between grains growing horizontally out from the sidewalls of the sacrificial material and those growing vertically from the surface of the previous layer. Since, in the case of NiTi, the sputtering produces an amorphous structure, it must be annealed to obtain a polycrystalline structure. In such cases extended annealing may be used to minimize such seams. In some embodiments, changing the angle of the sidewall of the first (e.g., sacrificial) material that is deposited prior to the structural material deposition can reduce the seam. The angle may be made significantly steeper or shallower than 90° to achieve the desired effect. In some embodiments, the deposition of the structural material (e.g. NiTi) may be adjusted to maximize the anisotropy of the process, typically to enhance the deposition rate on horizontal (i.e., parallel to the layers) surfaces compared with that on more vertical surfaces. In some embodiments, removing a certain thickness of material from the finished structure, particularly if the seam is not too distant from the edge of features, may be useful. Electropolishing, chemical etching, and other material removal methods may be used for this purpose.

Another effect associated with the topography of the previously-deposited sacrificial material is ‘shadowing’, caused by the protruding regions of the first material obscuring at least in part the edges of the apertures formed by the first material and thus affecting the thickness of the NiTi deposited therein. Shadowing effects may be mitigated by increasing the spacing between wafer and target in the sputtering chamber and/or increasing the diameter of the target with respect to the wafer. An alternative method to minimize shadowing effects is to periodically or continuously change the angle of the wafer with respect to the sputtering target. One way in which this may be accomplished is to mount the wafer (and/or target) on one or more rotating stages (e.g., a 2-axis tip/tilt stage) within the sputtering chamber and to move it during the deposition process (if desired, the process can be interrupted, the wafer re-positioned, and the deposition resumed).

Seams, shadowing defects and other potential effects of depositing over previous topography (due to the existence of patterned sacrificial material) in general are exacerbated by the aspect ratio of the sacrificial material features. Thus choosing a layer thickness which is no more than, and may be even a fraction of, the smallest significant feature on the layer, is a useful technique. In some embodiments, since there may be non-uniformity of the sacrificial material as-deposited, planarizing the sacrificial material (e.g., using diamond machining or lapping) before depositing the structural material may be beneficial. In some embodiments, prior to planarizing the sacrificial material a temporary filler material (e.g., wax such as Crystalbond made by Aremco Products, Valley Cottage, N.Y.) may be deposited within any voids or aperture in the sacrificial material to stabilize them. The temporary filler material may be removed subsequent to the planarization.

Multi-Layer Thin Film NiTi

The use of a multilayer processes, such as the EFAB® microfabrication technology, to fabricate devices or structures from ‘smart’ materials such as shape memory alloys (e.g. NiTi) that may be 100s of μm to several mm in height is an alternative to producing such devices using conventional machining (bending, laser cutting, etc.) of bulk shapes (tubing, wire, strip, etc.). One benefit to the multilayer additive fabrication approach is the ability to build sizeable structures from sputtered structural materials. Sputtered materials (e.g. NiTi) can be higher in purity than bulk materials, and EFAB processing may be less likely to introduce impurities than some conventional processing of bulk materials. It is known, for example, that drawing of NiTi tubing may introduce impurities that can cause pitting or other corrosion of a NiTi device formed there from.

Another benefit of a multilayer additive fabrication approach is the reduction in necessary post-processing such as shape-setting. Conventionally-fabricated NiTi devices (e.g., formed from wire or tube) typically need to be formed into the desired shape—often individually—and then heat set; this is commonly an iterative process. Devices produced from multiple layers can certainly be deformed and heat-set as well; for example, layers may be rotated out of their original planes, which can be advantageous in certain designs (e.g., fabrication of rotary joints such as hinges, bushings, and bearings with rotation around axes not parallel to the build axis). However, the ability to produce a complex, 3-D, freeform device can often obviate the need for further heat-setting. Such a device can then be deformed from its as-fabricated position and return to it either spontaneously (if superelastic at the operating temperature) once the stress is removed, or after heating if serving as a shape memory actuator.

A further benefit of a multi-layer approach (in which NiTi is deposited over a patterned sacrificial material and then planarized back in a process similar to Damascene processing) is that this approach to patterning NiTi, when compared with commonly-used laser cutting, does not produce thermal damage (including effects on shape-memory behavior such as shifting the transformation temperature), burrs, melting, cracks, dross on the surface, etc., and produces very clean edges. When compared with (normally isotropic) etching techniques to pattern NiTi, the multi-layer approach provides better resolution, greater accuracy, and sidewalls that are flatter and much closer to perpendicular to the major surfaces of the device (i.e. perpendicular to the surface of the layers). Overall, these advantages can make the approach of patterning a sacrificial material, followed by blanket depositing NiTi, followed by planarization, a preferred approach even if building devices with only a single layer (e.g., a stent fabricated as a flat sheet and then rolled up).

The ability to create multi-layer structures from NiTi also opens up entirely new capabilities in device fabrication. Some of these relate to the ability to alter the properties of the NiTi on a layer-by-layer basis. For example, each layer can be deposited with a different composition, producing compositionally-modulated structures. Since the transformation temperature of NiTi is dependent on the ratio of Ni to Ti (decreasing rapidly with increasing Ni content) and impurity concentrations, structures with modulated (e.g., graded) transformation temperature can be produced by carefully controlling the materials present in the sputtering chamber and/or the sputtering conditions.

Transformation temperature can also be modified by heat treatment, or aging. Normally such aging increases the transformation temperature. It is possible to age a multi-layer structure after each layer is deposited. In some embodiments the aging is done by putting the structure into an oven or furnace. In this case, previously-deposited layers will be heated similarly to the last-deposited layer. Since both time and temperature effect transformation temperature, then earlier-deposited layers will in general accumulate more time at high temperature, and thus tend to have a higher transformation temperature than later-deposited layers, providing a gradient that can be useful. In some embodiments, methods of heating (e.g., using a laser), especially if the heating is done quickly, pulsed, etc.) can preferentially heat the most recently-deposited layer(s), creating transformation temperature variation along the Z (layer-stacking) axis that may be controlled more arbitrarily. In general when heating structures prior to the deposition of all layers and the subsequent release of sacrificial material, if may be desirable to build the structures on a metallic substrate (vs. a ceramic one) to minimize the mismatch of coefficient of thermal expansion.

Transformation temperature can also be modified by cold-working the material; typically the more cold-working, the lower the transformation temperature. Multi-layer devices can be independently cold-worked on a layer-by-layer basis by, for example, shot peening or cold rolling of the NiTi after deposition (in some embodiments, after planarization of the layer). Distortions in the width of features caused by such processing can be characterized and then compensated for in the design of the device.

In some embodiments, providing different transformation temperatures for different layers (hereinafter, “heterogeneous transformation”) may be used to provide a gradual increase in force and/or displacement in a shape memory actuator. Normally, heating a shape memory actuator to its transformation temperature will cause the device to rather suddenly change its shape; to the extent that this change in shape is resisted, a force will thus be developed. With a heterogeneous transformation device, some layers will change shape and/or exert forces at different times than others do as the device is heated or cooled. Thus, for example, a heterogeneous transformation bar of NiTi may bend as it is heated just a small amount at first due to one or more of its layers reaching its transformation temperature; as the bar is further heated other layers will reach their transformation temperature and further bending will occur. In some embodiments, the thickness of layers, as well as their transformation temperature, may be used to control the displacements and forces produced by the device, since thinner layers will in general produce less relative force than thicker ones. Controlling both thickness and transformation temperature on a layer-by-layer basis thus enables a great deal of control over the behavior of a multi-layer device.

In one embodiment of a heterogeneous transformation device, the shapes obtained upon changing temperature can be different than those produced by shape setting. This may facilitate or enable shape-setting of devices which might otherwise be difficult or uneconomical. For example, consider a heterogeneous transformation wire having a gradient of transformation temperature across its diameter (i.e., it is comprised of layers with different transformation temperatures, such at a given layer has a transformation temperature higher than the layer below (or above) it, and a transformation temperature lower than the layer below ((or above) it. If this wire is shape-set in a fixture that stretches it and then raised to the transformation temperature of the layer with the lowest transformation temperature, then this layer will try to elongate, applying a force to the wire that tends to bend it away from that layer. As the temperature of the wire is raised further, additional layers will elongate until the force created by the wire in bending, and the amount of bending, is maximum. Increasing the temperature further will cause elongation of layers on the opposite side of the neutral axis, thus reducing the amount of bending and the bending force. Assuming all layers are equal in thickness, when the temperature has risen to the maximum transformation temperature in the wire, the bending forces will be balanced but the wire will be longer overall, possibly buckling. Thus, mere tensioning of the wire during shape setting is sufficient to program the wire to exhibit complex, bi-directional shape memory behavior including increasing bending, decreasing bending, and elongation all based on temperature change. Since it is possible to shape-set a large numbers of wires at the same time if only tensioning the wires is required, using a heterogeneous transformation device may facilitate scaling to higher volume production.

In another embodiment, the forces produced by different layers passing through their transformation temperatures at different times can be balanced, so as to create a very gradual increase in force. For example, consider a heterogeneous transformation wire that is heat set in its free state and has a gradient of transformation temperature from its bottom layer to its central (neutral axis) layer, and the opposite gradient from its central layer to its top layer. If the wire is stretched between two fixed objects, a certain tension will be applied to the objects. If the wire is then heated (e.g., by Joule/resistive heat), those layers with the lowest transformation temperature will begin to contract, increasing the tension, but in a balanced way, due to the symmetry of the transformation temperature distribution around the neutral axis. As the temperature rises, the transformation temperature of other layers will be reached and they too will contribute to the tension. At some temperature, all layers will be at or above their transformation temperature.

In some embodiments, heterogeneous transformation shape memory actuators can be made to exhibit multi-stage shape change by virtue of their multiple transformation temperatures. For example, at temperature T1, one portion of a heterogeneous transformation shape memory actuator, formed from one or more layers, may change its shape and perform some useful function, while the rest of the device remains in its original shape. As the temperature is changed to temperature T2, another portion of the device may change its shape, and so on. Such multi-stage shape changes can provide complex, pre-programmed/orchestrated, time-sequenced motions involving multiple layers, enabling multi-step actuation, assembly, or self-assembly, and other functions simply by changing the temperature of the device. Moving structures need not be composed strictly of layers which serve to. move them, but may include other layers as well.

FIGS. 19A-19D illustrate an example device that self-assembles as a result of undergoing temperature changes. FIG. 19A shows the components of the device. A plate 1002 that bends in the vertical plane when heated is anchored at its left end 1004, while a hole 1006 is provided toward its right end. A bar 1012 that bends in the horizontal plane when heated is anchored at its right end 1014, while a pin 1016 is provided at the bottom near its left end. All the components shown are assumed to belong to a single device, and the transformation temperature of plate 1002 is assumed to be lower than that of the bar 1012. In FIG. 19B, the temperature has been raised to the transformation temperature of the plate and the plate has bent downwards. In FIG. 19C, the temperature has been raised to the transformation temperature of the bar and the bar has bent inwards, such that the pin slides over the plate and enters the hole. In FIG. 19D, the device has been returned to its initial temperature, but the components do not return to their initial position: the pin and hole have provided a self-locking mechanism that introduces a non-reversibility, or hysteresis, into the device. Of course, reversible self-assembling (and thus, disassembling) devices can also be produced.

In some embodiments of heterogeneous transformation devices, different layers of a device may be heat set at different temperatures, either while the temperature of a device is changing in a single heat-setting process, or in multiple, separate processes. In some embodiments of heterogeneous transformation devices, some layers may be used to stress other layers into shapes that can then be programmed via heat setting. In some embodiments of heterogeneous transformation devices, some layers may be superelastic while others, having different transformation temperatures, may act as shape memory actuators. In some embodiments, certain layers may have a different microstructure than other layers. For example, one or more layers deposited early in the sequence of making a multi-layer device may be annealed, changing their structure from amorphous to polycrystalline. After the annealing, additional layers may then be added and then not annealed.

Composite NiTi Structures

In some embodiments, shape memory actuators with fast response times for high-frequency operation can be produced by creating high-surface area devices which can more easily dissipate heat to the surroundings. Fins and surface textures otherwise difficult or impossible to manufacture, including those based on fractal geometries, can be formed on such devices produced using a multi-layer process.

In some embodiments, composite devices may be formed which include not just one structural material (e.g. NiTi) but at least a second structural material as well. A second structural material can be on separate layers or the same layers as the first structural material and may be partially or fully encapsulated by the first structural material. The second structural material may be localized in one contiguous area or separated into multiple, isolated regions. If encapsulated or mostly encapsulated, the second material may be particulate in nature, and may either be loose or compacted. In some embodiments, the second material is a material with a much higher thermal conductivity than that of the first structural material. If completely encapsulated, the second structural material may actually be the sacrificial material whose exposed regions will eventually be removed. For example, copper has a thermal conductivity of 385 Wm-K, which is far higher than that of NiTi. Thus a shape memory actuator, in which the heated shape memory element (e.g. NiTi) can dissipate its heat through a second, high thermal conductivity material such as Cu, can be cycled at a higher frequency. Some second structural materials (e.g. Cu) may have higher electrical conductivity than the first structural material (e.g. NiTi). In such cases, if the device is heated electrically, the parallel current path through the second material can undesirably increase power consumption and decrease efficiency. Providing an electrically insulating, but still thermally conductive (preferably thin) barrier between the first structural material (i.e. the shape memory material) and the second structural material), and applying electrical current to the shape memory material, can mitigate this problem. In some embodiments, the second structural material is molten at the operating temperature of the device, such that it contributes increased thermal conductivity but minimally affects mechanical behavior such as stiffness.

By quickly absorbing heat, a second structural material can exhibit a phase change (melting or vaporizing) and provide faster response shape memory actuators. As the device is heated to produce a shape change, the phase-change temperature of the second structural material may be reached, suddenly extracting a large amount of heat from the first structural material causing its temperature to drop quickly. This helps to return the device to its unchanged shape before it would otherwise have a chance to cool by convection, conduction, or radiation if these were the only mechanisms available to extract the heat. In some embodiments, it is desirable that the transformation temperature of the first structural material (i.e. the shape memory material, e.g. NiTi) be somewhat lower than the temperature at which a phase change of the second structural material occurs. In this way, as the device is heated, the first structural material will exhibit its shape change, and by raising the temperature slightly further, the phase change incurred by the second structural material will abruptly extract heat from the first structural material. In other embodiments, the transformation temperature of the first structural material may be higher than the phase-change temperature of the second structural material. Depending on the extent to which the device is adiabatic, device geometry, and parameters such as the heat capacities and thermal conductivities of the first structural material and second structural material, it is possible to create mechanically oscillating devices using a shape memory first structural material and a second material that experiences a phase change.

In some embodiments, hollow shape memory actuators (e.g. based on NiTi) can be made such that a coolant (typically gas or liquid) can flow through the device to reduce its recovery time and allow higher frequency actuation. In some embodiments, the channels through which the coolant flows incorporate textures, fins, or other structures to increase surface area and heat transfer to the coolant. Preferably the coolant does not flow when the temperature of the device is rising to the temperature at which its shape changes, and is allowed to flow substantially only after the shape change has occurred, so as to return the device more quickly to its ‘cold’ shape. In some embodiments, flow of coolant may be controlled by deformation of device itself. The device may be designed such that a change in its shape controls the flow of coolant (e.g., opening a valve, changing the cross-sectional area of the flow channels, etc.). The device would be heated to actuate it, and the change in shape would then increase the flow of coolant; normally at approximately this time, the source of heat (e.g., electrical Joule heating of the device) would also be shut off.) After the device returns to its low-temperature shape, the flow would be reduced. Such a device will have a natural frequency which is considerably higher than the maximum cycling frequency of a device that does not use flowable coolant. If heat is applied at this frequency, the will oscillate. In some embodiments, the device may be hollow and contains a phase-change fluid which transfers heat from one portion of the device to another, i.e., the device is in part a heat pipe. The motion of heat within the device can be used to increase actuation frequency, produce oscillation, etc.

In some embodiments, the composite structure comprises both a shape memory material (e.g. NiTi) and a material with a significantly different coefficient of thermal expansion. For example, for the NiTi alloy Nitinol (about 56 wt. % Ni), the CTE ranges from 6.6 parts per million (ppm)/° C. (Martensite) to 11 ppm/° C. (Austenite), while the CTE of pure silver is 20 ppm/° C. In some embodiments, a bidirectional actuator can be produced by combining shape changes associated with differences in thermal expansion with those associated with shape memory.

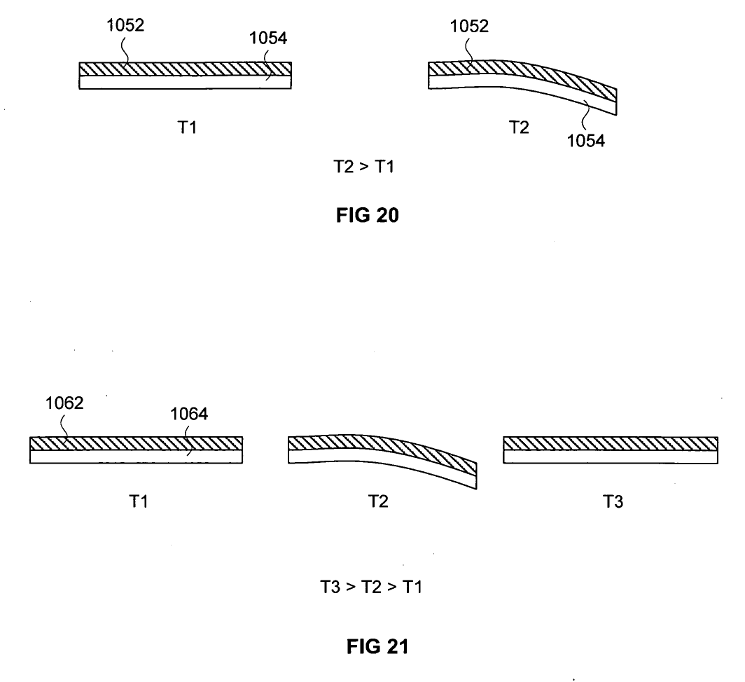

FIG. 20 provides an example of a typical bimorph device with a high CTE material 1052 on the top and a relatively low CTE material 1054 on the bottom. At a temperature of T1, the device is flat, but as the temperature is raised to T2, it bends downwards.

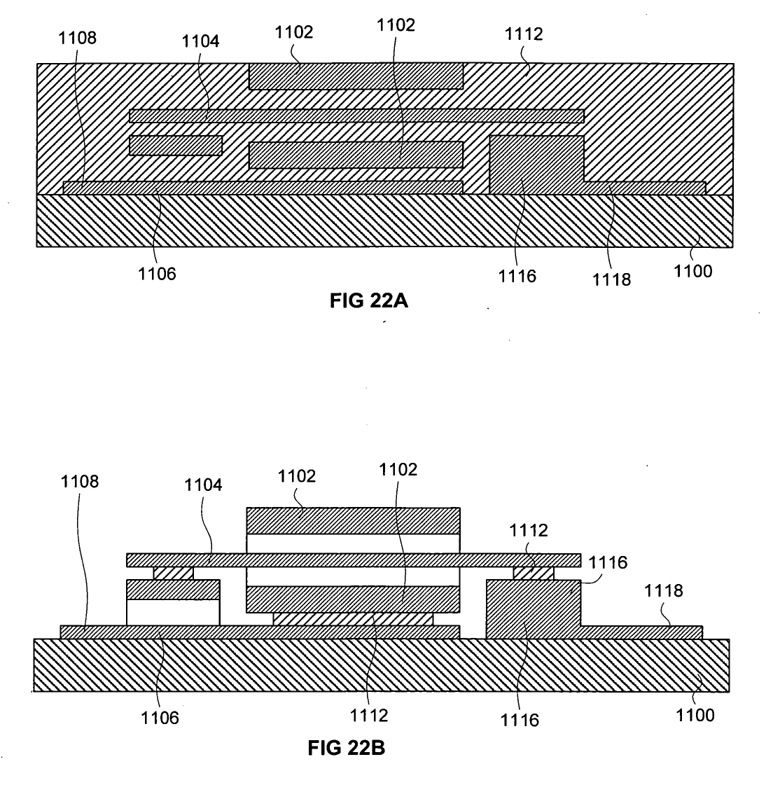

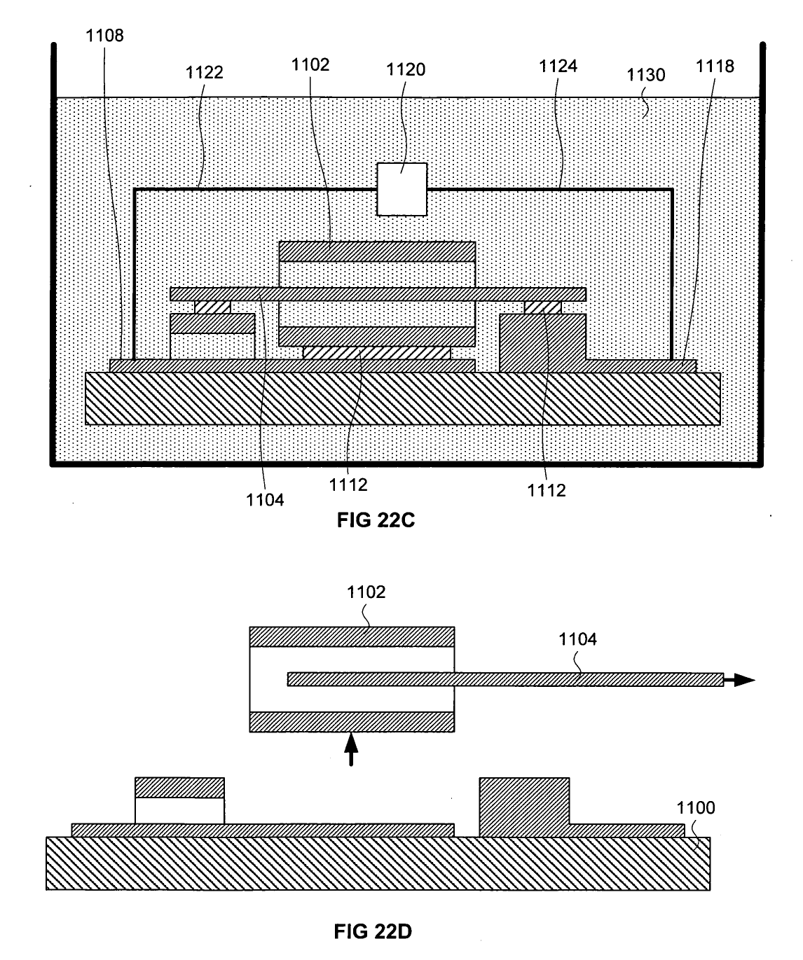

FIG. 21 provides another example of a bimorph in which the top material 1062 is a high CTE material such as Ag, and the bottom material 1064 is a shape memory material such as NiTi. At T1, the device is flat. As the temperature is raised to T2, the device bends downwards due to the difference in thermal expansion of the two materials. But when the temperature is raised further to T3, the shape memory behavior of the bottom material 1064 manifests itself, with the shape memory material trying to return to a configuration at which it was shape-set (here, assumed to be flat). This competes with the curvature effects associated with the mismatch of CTE and reduces the curvature of the device, potentially even returning it to its unbent shape as shown or bending it in the opposite direction. The device need not limit the materials to single layers, and the high CTE material 1062 may be encapsulated within the shape memory material 1064 or vice-a-versa, as long as most of each of the two materials are offset from the neutral axis of the structure.

In some embodiments, multi-layer devices can be produced which include regions of radiopaque materials such as gold (Au), tantalum (Ta), or platinum (Pt) which serve as markers during X-ray guided medical procedures. To minimize possible galvanic corrosion and enable the use of materials which are not normally sufficiently biocompatible (such as lead (Pb)), the radiopaque material in some embodiments is a second structural material that is embedded/encapsulated entirely within a first structural material that is biocompatible (e.g. NiTi) thus preventing any exposure to body fluids and tissue.

Electropolishing

In some embodiments, NiTi devices produced according to the invention may be electropolished. Electropolishing may be performed on a layer-by-layer basis, after each layer is planarized, or on the entire device after full or partial release of sacrificial material. Electropolishing (or in some cases, polishing, chemical etching, and other processes) may be used to remove sub-surface damage associated with planarization processes (e.g. associated with lapping), remove inclusions of foreign material from the device (e.g., constituents of slurries used for planarization), remove edge smearing defects associated with planarization, reduce surface roughness, round corners and edges to reduce potential tissue trauma, remove burrs due to handling, passivate the surface to make the device more biocompatible, etc. When electropolishing is performed on a layer-by-layer basis, it is also at a wafer scale (i.e. with potentially many identical or different devices being formed in a batch process on the wafer), and the sacrificial material electrically connects all the exposed features of structural material in the layer being processed. In some embodiments chemical etching may be used in place of electropolishing. When electropolishing or chemical etching removes surface damage associated with planarization operations that set layer boundary levels, the etching or polishing itself may be considered part of the planarization process (i.e. the boundary level setting process) even if the etching or polishing is material selective.

In some embodiments, electropolishing at a wafer scale (or device/die scale, if preferable) can also be performed after release or after partial release of sacrificial material. FIGS. 22A-22D depict, in cross-section, an arrangement/process which allows wafer-scale electropolishing of a fabricated device 1102 located on a substrate 1100. The arrangement shown provides at least one pre-aligned, co-fabricated electrode 1104 with the intent of eliminating or minimizing the need for additional electrodes. Pre-aligned, co-fabricated electrodes may be used in electropolishing the exterior surfaces of the devices, interior surfaces, or any other surfaces (e.g., the sides of struts in a stent). In FIGS. 22A-22D, the intent is to provide wafer-scale polishing of the inside of a tubular device (e.g., a stent), by way of example. FIG. 22 shows side cut view of the device after layer formation, prior to release of sacrificial material 1112, while FIG. 22 shows the device after a partial release of sacrificial material 1112. The device is built slightly above a device support 1106 (typically just one layer thick) and after partial release, sacrificial material 1112 remains in the gap between device and support as shown. Within the device is an electrode 1104 which similarly is connected to a support 1116 at each end (though one end may be sufficient) through incompletely-released sacrificial material remaining in a narrow gap between the electrode and the support. The device support 1106 is electrically continuous with a device pad 1108 for electrical contact, and the electrode support is continuous with an electrode pad 1118. By means of the yet-unreleased sacrificial material, electrical contact is thus achieved to both device and electrode. In practice, all device pads and all electrode pads, respectively, may be bussed together to facilitate wafer-scale electropolishing.

In FIG. 22, a power supply 1120 has been connected to the device pad 1108 and electrode pads 1118 via wires 1122 and 1124 and the wafer placed in a suitable electropolishing bath 1130, as is known to the art. With electric current applied, material is removed from the device (an increase in the inside diameter of the device is shown in the figure, not to scale). In FIG. 22, the release of sacrificial material 1112 has been completed and the device has been removed from the wafer and the electrode, designed for easy removal, is shown as being withdrawn from the central cavity of the device. The device may be further electropolished using more conventional methods, especially, for example, to polish its outer surfaces.

In an alternative embodiment to that shown in FIGS. 22A-22D, the electrode is supported at only one end, directly by the electrode support, with no intervening sacrificial material. In this case, after final release, the device is mechanically retained on the electrode (a mechanical stop may be provided to prevent it from sliding off prematurely) until the electrode is bent up, allowing the device to be removed. Alternatively, the electrode, and thus the device, may be removed by breaking it, in which case it may be supported at both ends.

In lieu of using a staged release approach and allowing unreleased sacrificial material to temporarily attach the device to the wafer and provide electrical contact, in some alternative embodiments, tabs or similar elements formed from structural material which ultimately make contact with device and electrode pads may be provided. In such cases, the wafer may be fully released before electropolishing and after such processing, the tabs may be broken off to release the device. In lieu of tabs, straps which surround at least a part of the device (and optionally, the electrode) and which make a low-resistant direct contact with the device (after the device has shifted slightly after release) may be used; low-resistance contact through the conductive electropolishing bath may also be used.

Immersion in Acid to Passivate

In some embodiments (e.g. when devices are to be used in medical applications) it may be desirable to passivate the surfaces of the device to increase its biocompatibility or corrosion resistance. Devices that are produced from a plurality of layers may have complex geometries, including internal features and nested elements that do not easily lend themselves to passivation using electropolishing techniques due to portions of the device electrically shielding other portions. In such cases, it may be preferable to passivate the device to increase its biocompatibility and/or corrosion resistance by chemical means. Such passivating may be achieved by immersing devices, either individually, or in batches (e.g. while still retained on the wafer (e.g., after release)) in a suitable passivating bath such as nitric acid or citric acid.

Co-fabrication of Mandrels for Heat-setting

In some embodiments it is desirable to change the as-fabricated shape of a device to another shape, and set this new shape as the shape that the device will return to after stressing and/or heating. Normally a tool such as a mandrel is used for setting such shapes in shape memory alloy structures (e.g. NiTi structures), with the setting process done at an elevated temperature. Mutual alignment of devices or portions of devices to such mandrels can be cumbersome and costly, and tends to be done on an individual basis or for just several devices at a time. The difficulty is compounded if the devices are of a small size and even more so if the device have microscale features.

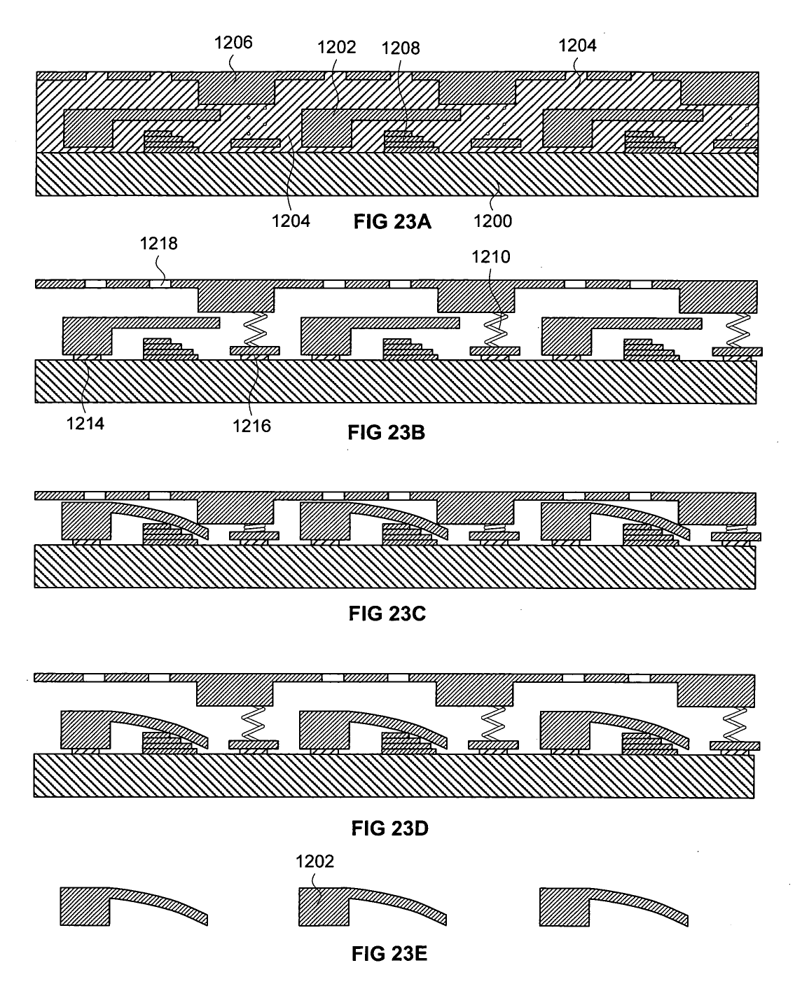

FIGS. 23A 23E illustrate an embodiment where mandrels for shape-setting are co-fabricated along with devices. In FIG. 23 a series of devices 1202 are shown on a substrate 1200 (e.g., a wafer) in cross-section, as fabricated, prior to release of sacrificial material 1204. Along with the devices are co-fabricated robust upper mandrels 1206 and lower mandrels 1208, as well as flexures 1210 (best seen in FIG. 23) here in the form of helical springs. In lieu of flexures, slides or other elements can be used to help stabilize the upper mandrel in the plane parallel to the layers, while allowing motion in the desired direction that deforms the devices. Structures other than the devices 1202 need not necessarily be fabricated from a shape memory material (e.g. NiTi). The non-device structures (and even portions of the devices themselves may be formed from different structural materials) and may exist on different layers from those that contain the shape memory material or materials or they may co-exist on the same layers along with a sacrificial material. As upper mandrels exist on separate layers from those that contain the devices, they may easily be made from a different structural material. In some embodiments, the upper mandrel may not be co-fabricated with the devices. In some embodiments, only one type of mandrel is required; for example, in the figure, it may be possible, depending on the desired shape, to eliminate the lower mandrels. FIG. 22B depicts the state of the process after the build has been partially released, though thin regions 1214 and 1216 of sacrificial material remain under the devices and the bases of the flexures, respectively, to anchor these temporarily to the substrate. In some embodiments, release may be facilitated by release holes 1218 in the upper mandrel. In alternative embodiments, individual upper mandrels for each device may be provided, allowing etchant to access the sacrificial material via gaps that separate the individual mandrels.

In FIG. 23, the state of the process is shown after the upper mandrel 1206 has been pushed downward to deflect part of each device 1202 around the lower mandrels 1208 while compressing the flexures 1210. Heat is applied while the upper mandrel is maintained in this position, setting the devices. If needed, the devices may be deflected and heat set gradually, approaching the final desired shape iteratively.

In FIG. 23, the upper mandrel 1206 has been allowed to rise up, but the devices 1202, now heat set, remain in their final shapes.

Finally, in FIG. 23, the remainder of the sacrificial material is removed to complete release of the individual devices 1202. Removal of the sacrificial material underneath the flexure bases allows the upper mandrel to be lifted away to expose the devices (assuming there is no other way to remove them), while removal of sacrificial material from under the devices frees them from the substrate. If it is not necessary to remove the upper mandrel to remove the devices, then the flexure bases may be directly attached to the substrate such that the upper mandrel remains permanently attached. A process similar to that of FIGS. 23-23E may also be used to produce permanent plastic deformation of non-shape memory materials: in effect, providing a wafer-scale stamping operation for small devices.

Further Comments and Conclusions

Structural or sacrificial dielectric materials may be incorporated into embodiments of the present invention in a variety of different ways. Such materials may form a third material or higher deposited on selected layers or may form one of the first two materials deposited on some layers. Additional teachings concerning the formation of structures on dielectric substrates and/or the formation of structures that incorporate dielectric materials into the formation process and possibility into the final structures as formed are set forth in a number of patent applications filed Dec. 31, 2003. The first of these filings is U.S. patent application Ser. No. 60/534,184 which is entitled “Electrochemical Fabrication Methods Incorporating Dielectric Materials and/or Using Dielectric Substrates”. The second of these filings is U.S. patent application Ser. No. 60/533,932, which is entitled “Electrochemical Fabrication Methods Using Dielectric Substrates”. The third of these filings is U.S. patent application Ser. No. 60/534,157, which is entitled “Electrochemical Fabrication Methods Incorporating Dielectric Materials”. The fourth of these filings is U.S. patent application Ser. No. 60/533,891, which is entitled “Methods for Electrochemically Fabricating Structures Incorporating Dielectric Sheets and/or Seed layers That Are Partially Removed Via Planarization”. A fifth such filing is U.S. patent application Ser. No. 60/533,895, which is entitled “Electrochemical Fabrication Method for Producing Multi-layer Three-Dimensional Structures on a Porous Dielectric”. Additional patent filings that provide teachings concerning incorporation of dielectrics into the EFAB process include U.S. patent application Ser. No. 11/139,262, filed May 26, 2005 by Lockard, et al., and which is entitled “Methods for Electrochemically Fabricating Structures Using Adhered Masks, Incorporating Dielectric Sheets, and/or Seed Layers that are Partially Removed Via Planarization”; and U.S. patent application Ser. No. 11/029,216, filed Jan. 3, 2005 by Cohen, et al., and which is entitled “Electrochemical Fabrication Methods Incorporating Dielectric Materials and/or Using Dielectric Substrates” . These patent filings are each hereby incorporated herein by reference as if set forth in full herein.

Though the embodiments explicitly set forth herein have considered multi-material layers to be formed one after another. In some embodiments, it is possible to form structures on a layer-by-layer basis but to deviate from a strict planar layer on planar layer build up process in favor of a process that interlaces material between the layers. Such alternative build processes are disclosed in U.S. application Ser. No. 10/434,519, filed on May 7, 2003, entitled Methods of and Apparatus for Electrochemically Fabricating Structures Via Interlaced Layers or Via Selective Etching and Filling of Voids. The techniques disclosed in this referenced application may be combined with the techniques and alternatives set forth explicitly herein to derive additional alternative embodiments. In particular, the structural features are still defined on a planar-layer-by-planar-layer basis but material associated with some layers are formed along with material for other layers such that interlacing of deposited material occurs. Such interlacing may lead to reduced structural distortion during formation or improved interlayer adhesion. This patent application is herein incorporated by reference as if set forth in full.

The patent applications and patents set forth below are hereby incorporated by reference herein as if set forth in full. The teachings in these incorporated applications can be combined with the teachings of the instant application in many ways: For example, enhanced methods of producing structures may be derived from some combinations of teachings, enhanced structures may be obtainable, enhanced apparatus may be derived, and the like.

| US Pat App No, | |
|---|---|
| Filing Date | |
| US App Pub No, | |
| Pub Date | Inventor, Title |
| 09/493,496 - | Cohen, “Method For Electrochemical Fabrication” |
| Jan. 28, 2000 | |
| 10/677,556 - | Cohen, “Monolithic Structures Including |
| Oct. 1, 2003 | Alignment and/or Retention Fixtures for Accepting |
| | Components” |
| 10/830,262 - | Cohen, “Methods of Reducing Interlayer |
| Apr. 21, 2004 | Discontinuities in Electrochemically Fabricated |
| | Three-Dimensional Structures” |
| 10/271,574 - | Cohen, “Methods of and Apparatus for Making |
| Oct. 15, 2002 | High Aspect Ratio Microelectromechanical |
| 2003-0127336A - | Structures” |
| Jul. 10, 2003 | |
| 10/697,597 - | Lockard, “EFAB Methods and Apparatus Including |
| Dec. 20, 2002 | Spray Metal or Powder Coating Processes” |
| 10/677,498 - | Cohen, “Multi-cell Masks and Methods and |
| Oct. 1, 2003 | Apparatus for Using Such Masks To Form Three- |
| | Dimensional Structures” |
| 10/724,513 - | Cohen, “Non-Conformable Masks and Methods |
| Nov. 26, 2003 | and Apparatus for Forming Three-Dimensional |
| | Structures” |
| 10/607,931 - | Brown, “Miniature RF and Microwave Components |
| Jun. 27, 2003 | and Methods for Fabricating Such Components” |
| 10/841,100 - | Cohen, “Electrochemical Fabrication Methods |
| May 7, 2004 | Including Use of Surface Treatments to Reduce |
| | Overplating and/or Planarization During |
| | Formation of Multi-layer Three-Dimensional |
| | Structures” |
| 10/387,958 - | Cohen, “Electrochemical Fabrication Method |
| Mar. 13, 2003 | and Application for Producing Three-Dimensional |
| 2003-022168A - | Structures Having Improved Surface Finish” |
| Dec. 4, 2003 | |
| 10/434,494 - | Zhang, “Methods and Apparatus for Monitoring |
| May 7, 2003 | Deposition Quality During Conformable Contact |
| 2004-0000489A - | Mask Plating Operations” |
| Jan. 1, 2004 | |
| 10/434,289 - | Zhang, “Conformable Contact Masking Methods |
| May 7, 2003 | and Apparatus Utilizing In Situ Cathodic |
| 20040065555A - | Activation of a Substrate” |
| Apr. 8, 2004 | |
| 10/434,294 - | Zhang, “Electrochemical Fabrication Methods |
| May 7, 2003 | With Enhanced Post Deposition Processing |
| 2004-0065550A - | Enhanced Post Deposition Processing” |
| Apr. 8, 2004 | |
| 10/434,295 - | Cohen, “Method of and Apparatus for Forming |
| May 7, 2003 | Three-Dimensional Structures Integral With Semi- |
| 2004-0004001A - | conductor Based Circuitry” |
| Jan. 8, 2004 | |
| 10/434,315 - | Bang, “Methods of and Apparatus for Molding |
| May 7, 2003 | Structures Using Sacrificial Metal Patterns” |
| 2003-0234179 A - | |
| Dec. 25, 2003 | |
| 10/434,103 - | Cohen, “Electrochemically Fabricated |
| May 7, 2004 | Hermetically Sealed Microstructures and Methods |
| 2004-0020782A - | of and Apparatus for Producing Such Structures” |
| Feb. 5, 2004 | |
| 10/841,006 - | Thompson, “Electrochemically Fabricated |
| May 7, 2004 | Structures Having Dielectric or Active Bases |
| | and Methods of and Apparatus for Producing |
| | Such Structures” |
| 10/434,519 - | Smalley, “Methods of and Apparatus for |
| May 7, 2003 | Electrochemically Fabricating Structures Via |
| 2004-0007470A - | Interlaced Layers or Via Selective Etching and |
| Jan. 15, 2004 | Filling of Voids” |
| 10/724,515 - | Cohen, “Method for Electrochemically Forming |
| Nov. 26, 2003 | Structures Including Non-Parallel Mating of |
| | Contact Masks and Substrates” |
| 10/841,347 - | Cohen, “Multi-step Release Method for |
| May 7, 2004 | Electrochemically Fabricated Structures” |
| 60/533,947 - | Kumar, “Probe Arrays and Method for Making” |
| Dec. 31, 2003 | |
| 60/534,183 - | Cohen, “Method and Apparatus for Maintaining |
| Dec. 31, 2003 | Parallelism of Layers and/or Achieving Desired |
| | Thicknesses of Layers During the Electrochemical |
| | Fabrication of Structures” |

Though various portions of this specification have been provided with headers, it is not intended that the headers be used to limit the application of teachings found in one portion of the specification from applying to other portions of the specification. For example, it should be understood that alternatives acknowledged in association with one embodiment, are intended to apply to all embodiments to the extent that the features of the different embodiments make such application functional and do not otherwise contradict or remove all benefits of the adopted embodiment. Various other embodiments of the present invention exist. Some of these embodiments may be based on a combination of the teachings herein with various teachings incorporated herein by reference.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims presented hereafter.

We Claim:

1. In a method of forming a multi-layer three-dimensional structure, including: (A) forming a plurality of successive layers of the structure with each successive layer, except for a first layer, adhered to a previously formed layer and with each successive layer comprising at least two materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement comprises:
depositing the first material via an electrodeposition process during formation of a given layer;
depositing the second material via a non-electrodeposition process during formation of a given layer,
wherein the first material is a metal and wherein the second material is an HDET metal, and wherein the first material is the sacrificial material and the second material is the structural material.

2. The method of claim 1 wherein at least a portion of a surface of a previous formed layer is treated to remove oxides over a previously deposited HDET metal to prepare the surface for receiving an electrodeposition of the first material during the formation of the given layer.

3. The method of claim 2 wherein the surface treatment comprises an anodic activation followed by a cathodic activation of the at least a portion of the surface.

4. The method of claim 1 wherein at least a portion of a surface of a previously formed layer undergoes a treatment to allow electrodeposition of the first material over an HDET metal or to improve adhesion of the first material to an HDET metal.

5. The method of claim 4 wherein the treatment comprises vacuum deposition of a relatively thin coating of the first material after which a relative thick coating of the first material is deposited via the electrodeposition process.

6. The method of claim 4, wherein the treatment comprises vacuum deposition of a relatively thin coating of a structural material which may be the same as the second material or different from the second material.

7. The method of claim 4 wherein prior to the treatment, the surface undergoes a preliminary treatment to remove any oxides.

8. In a method of forming a multi-layer three-dimensional structure, including: (A) forming a plurality of successive layers of the structure with each successive layer, except for a first layer, adhered to a previously formed layer and with each successive layer comprising at least two materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement comprises:
depositing the first material via a non-electrodeposition process during formation of a given layer;
depositing the second material via an electrodeposition process during formation of the given layer,
wherein the first material is an HDET metal and wherein the second material is a metal, and wherein the first material is the structural material and the second material sacrificial material.

9. The method of claim 8 wherein at least a portion of a surface of a previous formed layer is treated to remove oxides over a previously deposited HDET metal to prepare the surface for receiving an electrodeposition of the second material during the formation of the given layer.

10. The method of claim 8 wherein the surface treatment comprises an anodic activation followed by a cathodic activation of the at least a portion of the surface.

11. The method of claim, 8 wherein at least a portion of a surface of a previously formed layer undergoes a treatment to allow electrodeposition of the second material over an HDET metal or to improve adhesion of the second material to an HDET metal.

12. The method of claim 11 wherein the treatment comprises vacuum deposition of a relatively thin coating of the second material after which a relative thick coating of the second material is deposited via the electrodeposition process.

13. The method of claim 11 wherein the treatment comprises vacuum deposition of a relatively thin coating of a structural material which may be the same as the first material or different from the first material.

14. The method of claim 11 wherein prior to the treatment, the surface undergoes a preliminary treatment to remove any oxides.

15. In a method of forming a multi-layer three-dimensional structure, including: (A) forming a plurality of successive layers of the structure with each successive layer, except for a first layer, adhered to a previously formed layer and with each successive layer comprising at least three materials, one of which is a structural material and the other of which is a sacrificial material, and wherein each successive layer defines a successive cross-section of the three-dimensional structure, and wherein the forming of each of the plurality of successive layers includes: (i) depositing a first of the at least two materials; (ii) depositing a second of the at least two materials; and (B) after the forming of the plurality of successive layers, separating at least a portion of the sacrificial material from the structural material to reveal the three-dimensional structure, wherein the improvement comprises:
depositing a first material structural or sacrificial material during formation of a given layer;
depositing a second structural or sacrificial material during formation of the given layer,
depositing a third structural or sacrificial material during formation of the given layer,
wherein at least one of the first-third materials is a sacrificial material, at least one of the first-third materials is a structural material, at least two of the first-third materials are metals, and least one of the metals is electrodeposited, and at least one structural material is an HDET metal

16. The method of claim 15 wherein at least a portion of a surface of a previous formed layer is treated to remove oxides over a previously deposited HDET metal to prepare the surface for receiving an electrodeposition of at least one of the metals during the formation of the given layer.

17. The method of claim 15 wherein the surface treatment comprises an anodic activation followed by a cathodic activation of the at least a portion of the surface.

18. The method of claim 15 wherein at least a portion of a surface of a previously formed layer undergoes a treatment to allow electrodeposition of at least one of the metals over an HDET metal on a previous layer or to improve adhesion of the electrodeposited metal to the HDET metal on the previous layer.

19. The method of claim 18 wherein the treatment comprises vacuum deposition of a relatively thin coating of a sacrificial material after which a relative thick coating of the sacrificial material is deposited via an electrodeposition process.

20. The method of claim 18 wherein the treatment comprises vacuum deposition of a relatively thin coating of a structural material which may be the same as the electrodeposited metal of different from the first material.
